(19) United States
(12) Patent Application Publication
(10) Pub. No.: US 2026/0156051 A1
(43) Pub. Date: Jun. 4, 2026

(54) DATA PROCESSING APPARATUS, CONTROL METHOD THEREOF, AND STORAGE MEDIUM

(71) Applicant: CANON KABUSHIKI KAISHA, Tokyo (JP)

(72) Inventor: TAKAFUMI MIZUNO, Tokyo (JP)

(21) Appl. No.: 19/401,222

(22) Filed: Nov. 25, 2025

(30) Foreign Application Priority Data
Nov. 29, 2024 (JP) 2024-209029

(51) Int. Cl. H04L 41/50

(52) U.S. Cl. CPC H04L 41/50

(57) ABSTRACT

It eliminates a possibility that unintended data transfer between lines is performed for data received by an Internet fax function in a conventional apparatus such as an MFP connectable to the lines. In the MFP, a transfer restriction condition is set for each transfer condition related to the Internet fax function, data from an external apparatus is received by the Internet fax function via any of plural network interfaces, whether to execute transmission of the received data is determined based on information indicating the network interface used in the data reception and destination information according to the transfer condition, the transmission of the data determined to execute the transmission is executed using the destination information via any of the plural network interfaces, and the transmission of the data determined to not execute the transmission is not executed using the destination information.

### BACKGROUND

### Field of the Technology

The aspect of the embodiments relates to a data processing apparatus, a control method thereof, and a storage medium storing a program for executing the control method.

### Description of the Related Art

In recent years, there has been a multifunction peripheral that includes a plurality of network interfaces (network lines) and can be connected to a plurality of systems of networks. A single multifunction peripheral having such a function can be connected to different networks. For example, the multifunction peripheral can connect to both a public Internet line and a private intranet line without other devices. Thus, for example, when transmitting a scanned image to a file server, the multifunction peripheral can directly transmit the scanned image to the file server on the Internet side as well as the intranet side.

Japanese Patent No. 5511332 discloses a technique for determining whether or not to permit data transmission based on a network line used for reception and a network line used for transmission.

Here, some multifunction peripherals have a file server function and an Internet fax function, and there are cases where not only an image is transmitted but also an image is received.

Some multifunction peripherals have a reception/transfer function of transferring data received by the Internet fax function or the like to another device. In such a multifunction peripheral, since the received data is automatically transmitted to a transfer destination in the reception/transfer function, there is a possibility that the data is transmitted to a prohibited line by the unintended transfer.

There is also a case where a network line on the intranet side and a network line on the Internet side are connected by a gateway. Communications such as SMTP (Simple Mail Transfer protocol) and the like utilized to transmit and receive mail messages may pass through the gateway. For example, when the received data is transferred by an e-mail, a mail server on the intranet side and a mail server on the Internet side are connected by the gateway. In such a case, in the technique of Japanese Patent No. 5511332, since whether or not transmission is possible is determined based on the line of a network I/F which receives data and the line of a network I/F which transmits data, there is a possibility that the data is transmitted to the transmission-prohibited line via the gateway. Such an issue arose in a data processing apparatus such as the multifunction peripheral or the like.

### SUMMARY

In the disclosure, there is provided an apparatus having a plurality of network interfaces and an Internet fax function, the apparatus including, a receiving unit configured to receive data transmitted from an external apparatus, by the Internet fax function via any of the plurality of network interfaces, a determining unit configured to determine whether or not to execute transmission of the received data, based on network information indicating the network interface used in a case where the receiving unit receives the data, and destination information according to a transfer condition related to the Internet fax function, and a transmitting unit configured to execute, via any of the plurality of network interfaces, the transmission of the received data received and for which the determining unit determines that the transmission is executed, the transmission being executed according to the transfer condition and using the destination information, wherein the transmission using the destination information is not executed on the received data and for which the determining unit determines that the transmission is not executed.

Features of the disclosure will become apparent from the following description of embodiments with reference to the attached drawings. The following description of embodiments is described by way of example.

### BRIEF DESCRIPTION OF THE DRAWINGS

FIG. 1 is a diagram illustrating a system configuration according to embodiments of the disclosure.

FIG. 2 is a block diagram illustrating a hardware configuration of a controller unit of an MFP.

FIG. 3 is a block diagram illustrating a hardware configuration of a mail server/client terminal.

FIG. 4 is a block diagram illustrating a software configuration executed by the controller unit of the MFP.

FIG. 5A is a diagram illustrating a screen for setting network data separation.

FIG. 5B is a diagram illustrating a screen for setting the network data separation.

FIG. 6 is a diagram illustrating a transfer setting list screen.

FIG. 7A is a diagram illustrating a screen for performing a transfer setting.

FIG. 7B is a diagram illustrating a screen for performing the transfer setting.

FIG. 7C is a diagram illustrating a screen for performing the transfer setting.

FIG. 7D is a diagram illustrating a screen for performing the transfer setting.

FIG. 7E is a diagram illustrating a screen for performing the transfer setting.

FIG. 8 is a diagram illustrating an address book screen according to a first embodiment.

FIG. 9 is a diagram illustrating an example of an e-mail to be transmitted when reception/transfer is restricted in the first embodiment.

FIG. 10 is a diagram illustrating an example of a data structure for recording the setting of the network data separation of the MFP.

FIG. 11A is a diagram illustrating an example of a data structure for recording the transfer setting of the MFP.

FIG. 11B is a diagram illustrating an example of a data structure for recording the transfer setting of the MFP.

FIG. 12 is a flowchart illustrating an example of a transfer process in the MFP according to the first embodiment.

FIG. 13A is a diagram illustrating an example of a screen of an address book corresponding to a group destination in a second embodiment.

FIG. 13B is a diagram illustrating an example of a screen of the address book corresponding to the group destination in the second embodiment.

FIG. 13C is a diagram illustrating an example of a screen of the address book corresponding to the group destination in the second embodiment.

FIG. 14 is a diagram illustrating an example of a screen for performing a transfer setting of the group destination displayed on the MFP according to the second embodiment.

FIG. 15A is a diagram illustrating an example of an e-mail to be transmitted when reception/transfer is restricted for a group destination in the second embodiment.

FIG. 15B is a diagram illustrating an example of an e-mail to be transmitted when the reception/transfer is restricted in the second embodiment.

FIG. 16A is a flowchart illustrating an example of a transfer process corresponding to the group destination in the MFP according to the second embodiment.

FIG. 16B is a flowchart illustrating an example of the transfer process corresponding to the group destination in the MFP according to the second embodiment.

### DESCRIPTION OF THE EMBODIMENTS

Hereinafter, embodiments of the disclosure will be described with reference to the drawings. However, all of the features described in the embodiments are not necessarily essential to solutions of the disclosure.

### First Embodiment

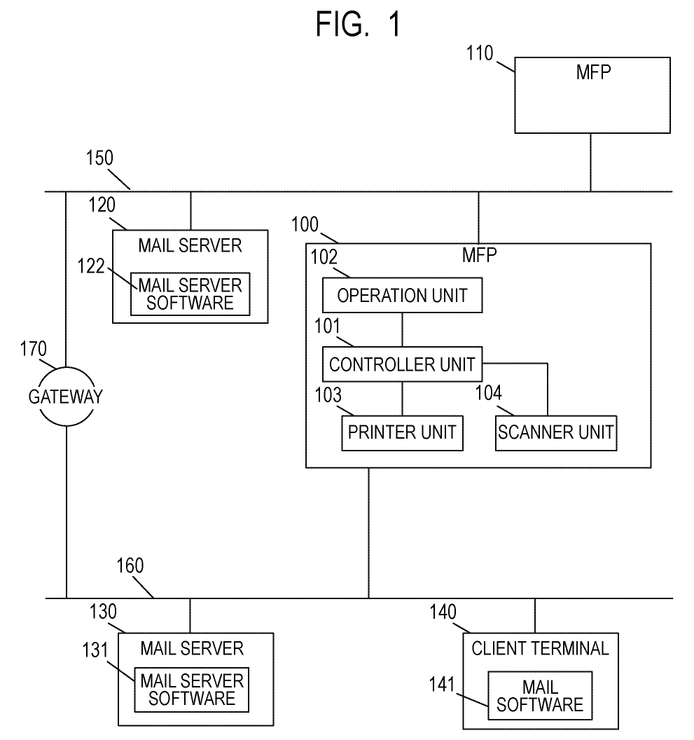

FIG. 1 is a diagram illustrating a system configuration according to one embodiment of the disclosure.

The system according to the embodiment includes an MFP 100, an MFP 110, a mail server 120, a mail server 130, and a client terminal 140.

The MFP 100, the MFP 110, and the mail server 120 are connected via a network 150. The mail server 130 and the client terminal 140 are connected to each other via a network 160.

The MFP 100 has a plurality of network interfaces (network I/Fs) and is connected to the network 150 and the network 160. The MFP 100 functions as a data processing apparatus that is capable of transmitting and receiving data via these networks.

For example, the MFP 100 can receive data transmitted from an external apparatus by an Internet fax function via any of the plurality of network I/Fs, and transmit the received data using destination information according to a transfer condition via any of the plurality of network I/Fs.

The MFP 100 has a network data separation function. The network data separation function restricts data exchange between the network 150 and the network 160. The network 150 and the network 160 are connected to each other by a gateway 170.

Each of the MFPs 100 and 110 is an image forming apparatus, and reads an image by scanning, prints an image by a printer, and performs fax transmission and reception.

Each of the MFPs 100 and 110 includes an operation unit 102 that performs input/output with a user. The MFP 100 also includes a printer unit 103 that outputs electronic data to a paper medium. The MFP 100 also includes a scanner unit 104 that reads a paper medium and converts the read paper medium into electronic data.

The operation unit 102, the printer unit 103, and the scanner unit 104 are connected to a controller unit 101, and perform functions as a multifunction peripheral under the control of the controller unit 101.

The mail server 120 and the mail server 130 are servers that perform transmission and reception of e-mail (electronic mail), and mail server software 122 and mail server software 131 interpret the SMTP protocol and the POP protocol and perform transmission and reception of an e-mail. Since the mail server is well known, the description of the configuration thereof will be omitted.

The client terminal 140 is a terminal that is used by a user, and mail software 141 communicates with the mail server software 131 to transmit and receive an e-mail. Examples of the client terminal include a notebook personal computer (PC) and a tablet terminal.

Incidentally, in FIG. 1, only the configuration for explaining the embodiment is described, and it is needless to say that a configuration other than the above configuration may be included as long as implementation of the disclosure is satisfied, and a connection form between the constituent elements is not limited thereto.

Here, for example, the network 150 is an intranet, and the network 160 is the Internet. In the network data separation function described above, it is assumed that the data received on the intranet (network 150) side of the MFP 100 is not transferred to the Internet (network 160).

It is assumed that the transfer function of the MFP 100 is set to transfer received data by mail. Further, in the MFP 100, it is assumed that the mail server 120 on the network 150 is set as a mail server for mail transmission.

At this time, it is assumed that data is transmitted from the MFP 110 on the network 150 to the MFP 100 via an Internet fax. In the MFP 100 that has received the data, the transfer function operates to transmit the received data by mail.

At this time, since the mail server 120 set in the MFP 100 is on the network 150, the restriction of the network data separation function is not imposed. If the received data is transferred to the mail server 120 as a mail, the mail server 120 is connected to the network 160 via the gateway 170, and the mail is relayed to the mail server 130 on the network 160.

Then, it is assumed that the client terminal 140 in the network 160 receives the mail from the mail server 130. In this case, as a result, the data received by the MFP 100 from the network 150 side is transmitted to the network 160 side which is supposed to be prohibited from being transferred.

As just described, in one embodiment, when the restriction by the network data separation function is performed focusing on only the line, there is a possibility that the received data is transmitted to the restricted line.

In the embodiment, a configuration for suppressing occurrence of such a situation will be described.

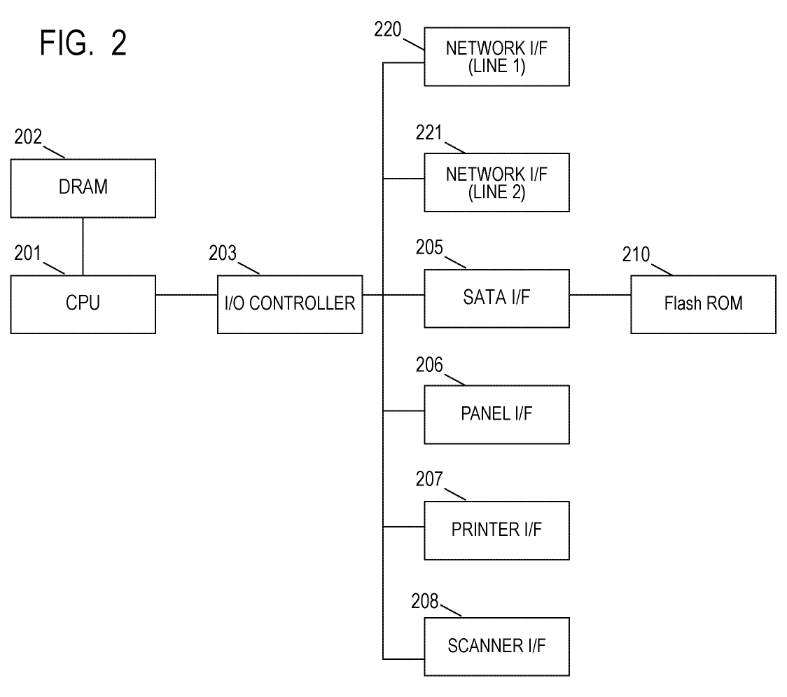

FIG. 2 is a block diagram illustrating a hardware configuration of the controller unit 101 of the MFP.

A CPU 201 performs a main arithmetic process in the controller. The CPU 201 is connected to a DRAM 202 via a bus.

The DRAM 202 is used by the CPU 201 as a working memory for temporarily arranging program data representing an arithmetic instruction and data to be processed in the process of arithmetic operation by the CPU 201.

The CPU 201 is connected to an I/O controller 203 via a bus.

The I/O controller 203 performs input/output to/from various devices in accordance with instructions from the CPU 201. The I/O controller 203 is connected to a SATA (Serial Advanced Technology Attachment) I/F 205, to which a Flash ROM 210 is connected.

The CPU 201 uses the Flash ROM 210 to perpetually store programs for realizing the functions of the MFP and document files. Instead of the Flash ROM, a large-capacity storage device such as an HDD (Hard Disk Drive) or an SSD (Solid State Drive) may be connected.

A network I/F (line 1) 220 and a network I/F (line 2) 221 are connected to the I/O controller 203. In the embodiment, two network I/Fs are provided, but three or more network I/Fs may be connected.

A wired LAN device or a wireless LAN device is connected to the network I/Fs 220 and 221.

Further, a panel I/F 206 is connected to the I/O controller 203, and the CPU 201 realizes input/output for the user with respect to the operation unit 102 via the panel I/F 206.

Further, a printer I/F 207 is connected to the I/O controller 203, and the CPU 201 realizes a paper medium output process using the printer unit 103 via the printer I/F 207.

The MFP 100 includes various applications for using the functions of the MFP.

Examples of the functions of the MFP include a copy function, a transmission function, a fax function, and a box function. Hereinafter, each function will be described.

### Copy Function

For example, when the MFP 100 performs the copy function, the CPU 201 reads program data from the Flash ROM 210 into the DRAM 202 via the SATA I/F 205. Then, the CPU 201 detects a copy instruction from the user to the operation unit 102 via the panel I/F 206 in accordance with the program read into the DRAM 202.

Upon detecting the copy instruction, the CPU 201 receives a document as electronic data from the scanner unit 104 via a scanner I/F 208, and stores the electronic data in the DRAM 202. Further, the CPU 201 performs a color conversion process or the like suitable for output on image data stored in the DRAM 202. The CPU 201 transfers the image data stored in the DRAM 202 to the printer unit 103 via the printer I/F 207, and performs a process of outputting the image data on the paper medium.

### Transmission Function

In the transmission function, a process in which the CPU 201 detects a transmission instruction from the user is the same as the above-described copy function. The transmission instruction includes a transmission protocol, a transmission destination designation, an image format, and the like from the user. The transmission protocol is an SMB, an FTP, or the like, and the transmission destination designation is designated by an UNC (Universal Naming Convention), for example. The image format is a JPEG, a PDF, or the like.

Upon detecting the transmission instruction, the CPU 201 receives the document as the electronic data from the scanner unit 104 via the scanner I/F 208, and stores the electronic data in the DRAM 202. Further, the CPU 201 performs an image format conversion or the like designated by the user on the image data stored in the DRAM 202.

Then, the CPU 201 transmits the image data stored in the DRAM 202 to a transmission destination via the network I/Fs 220 and 221 according to the protocol designated by the user. The transmission may be performed by specifying a storage server as the transmission destination and using a mechanism of authorization using an access token.

### Fax Function

In the fax function, the process in which the CPU 201 detects a fax instruction from the user is the same as the above-described copy function.

Upon detecting the fax instruction, the CPU 201 receives the document as the electronic data from the scanner unit 104 via the scanner I/F 208, and stores the electronic data in the DRAM 202. Further, the CPU 201 performs an image format conversion for fax on the image data stored in the DRAM 202.

Then, the CPU 201 transfers the image data stored in the DRAM 202 to a telephone number of the fax designated by the fax instruction via a telephone network (not shown) to which the fax I/F 209 is connected.

The fax via the telephone network is an example, and may be an Internet fax. The Internet fax is a function of transmitting and receiving fax via the Internet.

The document is transmitted by being attached to an e-mail as an image file. When the network I/Fs 220 and 221 detect reception of a fax image, the CPU 201 transfers the received image file to the printer unit 103 via the printer I/F 207 to perform printing.

Further, the image file of the data received by the CPU 201 can be temporarily saved without being printed. For example, the CPU 201 stores the image file of the received data in the Flash ROM 210 connected via the SATA I/F 205.

### Box Function

The box function is a function of saving an image scanned by the CPU 201 in a storage area inside the MFP 100 or in a memory medium connected to the MFP 100. Further, the MFP 100 functions as a file server so as to publish the image saved in the MFP 100 to an external PC (not shown) or another MFP.

In the box function, the process in which the CPU 201 detects a box saving instruction from the user is the same as the above-described copy function. The box saving instruction includes a saving destination designation, an image format, and the like from the user. The saving destination is a path of a storage inside the MFP 100 or a memory medium connected to the MFP 100. The image format is the JPEG, the PDF, or the like.

Upon detecting the box saving instruction, the CPU 201 receives the document as the electronic data from the scanner unit 104 via the scanner I/F 208, and stores the electronic data in the DRAM 202. Further, the CPU 201 performs an image format conversion designated by the user on the image data stored in the DRAM 202.

Then, the CPU 201 transfers the image data stored in the DRAM 202 to a saving destination designated by the user, such as the Flash ROM 210 inside the MFP 100 or a memory medium (not shown), via the SATA I/F 205.

In the fax function, the received image may not be printed, but may be converted into a format viewable by a PC or the like and saved in a box. Further, as the box function, the MFP 100 functions as a file server such as an SMB server, and publishes the contents of the Flash ROM 211.

In the box function, the CPU 201 detects a box access instruction from the outside via the network I/F 204. The box access instruction includes an image file path of an access destination, or the like.

The CPU 201 transfers the image data stored in the Flash ROM 210 corresponding to the designated image file path to a request source of the box access instruction via the network I/F 204.

There are a fax box and a system box as the boxes in which the image of the received fax is stored.

The system box is a storage location where a fax document is temporarily saved when the image data received by the fax is received in a memory without being printed. There is one system box in the equipment.

The fax box is a storage location where a received fax document is temporarily saved when the received fax document matches a transfer condition in a reception/transfer setting described later. The fax box includes a plurality of boxes, and a personal identification number can be set in each box, so that the box can be protected by the personal identification number.

Note that the above is an example of the functions of the MFP 100, and other functions may be provided.

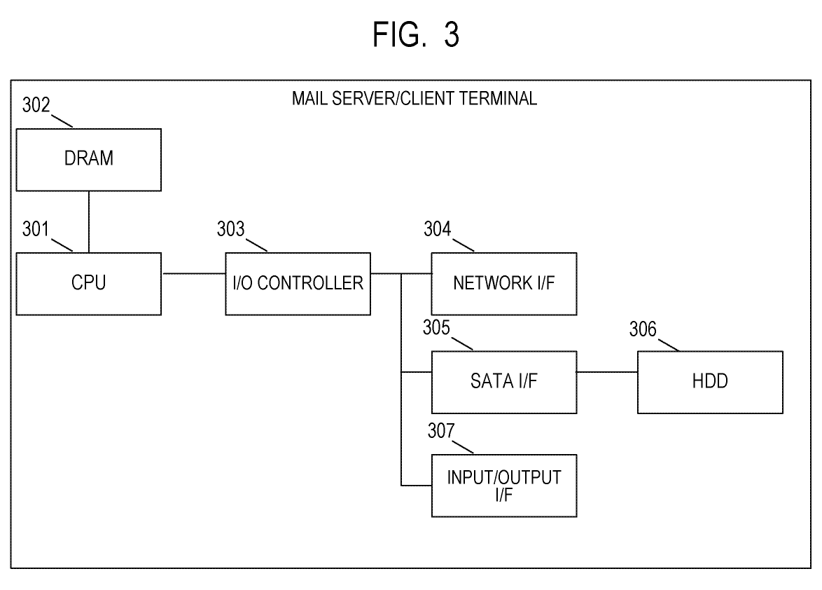

FIG. 3 is a block diagram illustrating a hardware configuration of the client terminal 140, the mail server 120, and the mail server 130.

A CPU 301 is connected to a DRAM 302 via a bus.

The DRAM 302 is used by the CPU 301 as a working memory for temporarily arranging program data representing an arithmetic instruction and data to be processed in the process of arithmetic operation by the CPU 301.

The CPU 301 is connected to an I/O controller 303 via a bus. A network I/F 304 is connected to the I/O controller 303.

A wired LAN device, a wireless LAN device, or a data communication device is connected to the network I/F 304. The CPU 301 realizes communication on the network 150 by controlling the wired LAN device, the wireless LAN device, and the data communication device via the network I/F 304.

The I/O controller 303 performs input/output to/from various devices in accordance with instructions from the CPU 301. The I/O controller 303 is connected to a SATA (Serial Advanced Technology Attachment) I/F 305, to which an HDD 306 is connected. Instead of the HDD, another mass storage device such as an SSD may be connected.

The CPU 301 is used to perpetually store setting values of programs such as the mail software 141, the mail server software 122, and the mail server software 131 in the HDD 306.

Further, an input/output I/F 307 is connected to the I/O controller 303, and the CPU 301 realizes input/output for the users of the client terminal 140, the mail server 120, and the mail server 130 connected via the input/output I/F 307. As an example, a touch panel serving also as an input/output may be connected to the input/output I/F 307, or an output device such as a display that performs display and an input device such as a keyboard or the like that performs input may be connected to the input/output I/F 307.

Note that the mail software 141 operating on the client terminal 140, the mail server software 122 operating on the mail server 120, and the mail server software 131 operating on the mail server 130 have known software configurations and are not the essence of the embodiment, and thus details thereof will be omitted.

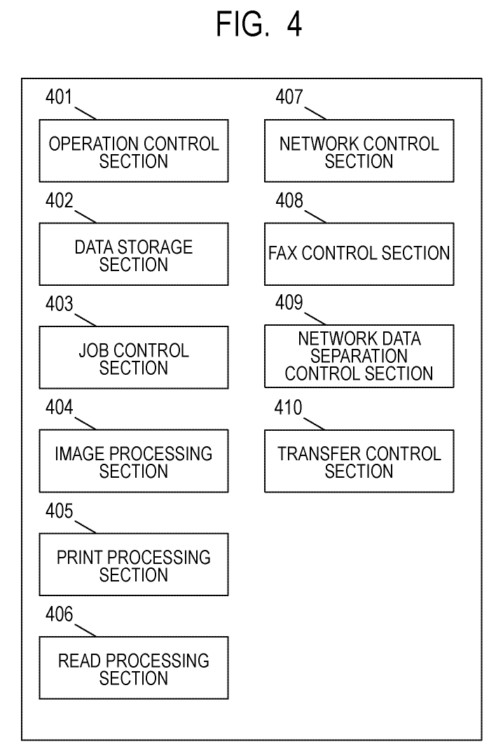

FIG. 4 is a block diagram illustrating a software configuration executed by the controller unit 101 of the MFP 100. In the controller unit 101 of the MFP 100, the CPU 201 loads the program stored in the Flash ROM 211 into the DRAM 202 and executes the program, thereby realizing the functions of the software configuration illustrated in the figure.

An operation control section 401 controls display of a screen image for a user on the operation unit 102, controls detection of a user operation via the operation unit 102, and controls execution of the process associated with a screen component such as a button displayed on the screen.

A data storage section 402 stores data in the Flash ROM 211 and reads data from the Flash ROM 211, in accordance with requests from another control section.

A job control section 403 controls execution of a job in accordance with an instruction from another control section.

An image processing section 404 processes image data into a format suitable for each application, in accordance with an instruction from the job control section 403.

A print processing section 405 prints and outputs an image on a paper medium via the printer I/F 207 in accordance with an instruction from the job control section 403.

A read processing section 406 reads the set document via the scanner I/F 208 in accordance with an instruction from the job control section 403.

A network control section 407 inputs/outputs data from/to a LAN, a Wi-Fi, or a public line network via the network I/Fs 220 and 221 in accordance with an instruction from each control section. The data storage section 402 allows an external device to access the data stored in the Flash ROM 210 via the network control section 407. Examples of the data stored in the Flash ROM 210 include images of the PDF, the JPEG, the TIFF and the like.

A fax control section 408 receives fax data from the network control section 407 in accordance with an instruction from the job control section 403, instructs the print processing section 405 to print the fax data, converts the fax data into an image of the PDF, the JPEG or the like, and stores the converted image in the data storage section 402. The fax control section 408 transmits image data read by the read processing section 406 as the fax data via the network control section 407.

A network data separation control section 409 determines whether or not it is possible to transmit data to the network I/Fs 220 and 221. For example, the network data separation control section 409 determines which of the network I/Fs 220 and 221 the received data is received from, and determines whether or not it is possible to execute a process via the network I/F used as a transmission destination. When it is not possible, the network data separation control section 409 controls the network control section 407 not to execute transmission.

A transfer control section 410 performs a process related to transfer of the received image data to another device. For example, a process of transferring the image data received by the fax function to an e-mail, an Internet fax, a file server, another fax device, or the like is performed. For example, the transfer control section 410 converts the image data received using the network control section 407 into an image according to the setting using the image processing section 404, and temporarily stores the image in the data storage section 402.

The transfer control section 410 transmits the image data temporarily stored in the data storage section 402 to the transfer destination by using the network control section 407 again. At this time, the transfer control section 410 determines whether or not reception/transfer is possible by using the network data separation control section 409. Details of this determination will be described later.

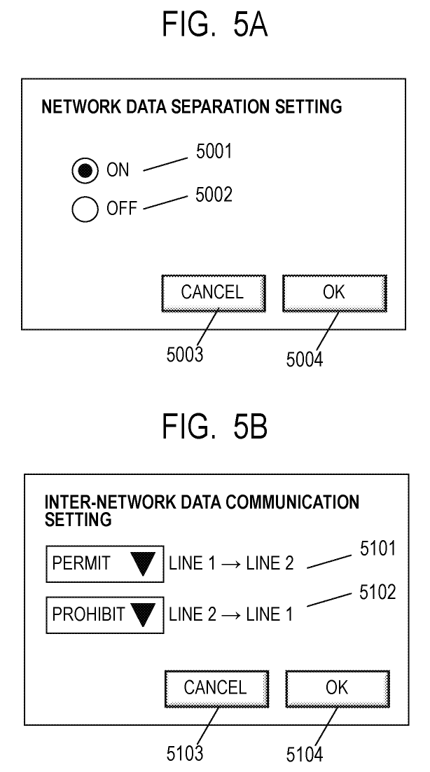

FIGS. 5A and 5B are diagrams illustrating screens of network data separation setting for performing data separation for a plurality of network I/Fs in the MFP 100.

FIG. 5A corresponds to an example of the screen for an administrator of the MFP 100 to set whether or not to perform network data separation.

Any one of radio buttons 5001 and 5002 can be selected for the network data separation setting. When performing the network data separation, the button 5001 is selected, and when not performing the network data separation, the button 5002 is selected.

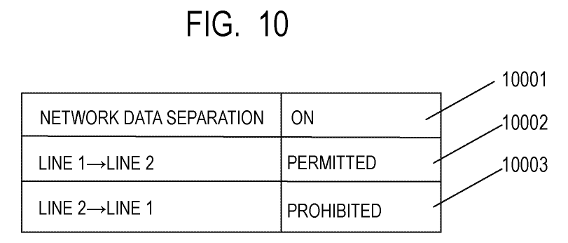

When an OK button 5004 is pressed, the network data separation setting performed in FIG. 5A is saved in the Flash ROM 210, for example, as indicated by a setting 10001 in FIG. 10, which will be described later.

When a cancel button 5003 is pressed, the network data separation setting performed in FIG. 5A is discarded without being saved.

FIG. 5B corresponds to an example of the screen for setting which combination of lines is used to permit data transmission among the plurality of network I/Fs when it is set that data separation is performed in FIG. 5A (when ON of the button 5001 is selected). Hereinafter, the network I/F 220 is referred to as a line 1, and the network I/F 221 is referred to as a line 2.

A setting 5101 is a setting as to whether or not transmission of the data received on the line 1 to the line 2 is permitted. In the example of FIG. 5B, “permit” is set, so that the data received on the line 1 can be transmitted to the line 2.

A setting 5102 is a setting as to whether or not transmission of the data received on the line 2 to the line 1 is permitted. In the example of FIG. 5B, “prohibit” is set, so that it is impossible to transmit the data received on the line 2 to the line 1, and an error occurs when attempting to perform the data transmission.

In the embodiment, the transmission of the data received on the line 1 to the line 1 and the transmission of the data received on the line 2 to the line 2, which are the transmissions between the same lines, are not restricted.

Although not shown in FIG. 5B, a setting may be provided as to whether or not data can be transmitted between the same lines. Alternatively, when there are more lines, the lines of the reception source and the transmission destination may be selected.

When an OK button 5104 is pressed, a data communication setting between network data performed in FIG. 5B is saved in the Flash ROM 210, for example, as indicated by settings 10002 and 10003 in FIG. 10 described later.

When a cancel button 5103 is pressed, the communication setting between network data performed in FIG. 5B is discarded without being saved.

In the embodiment, examples of the setting whether or not to permit the transmission of the data received on the line 1 to the line 2 and the setting whether or not to permit the transmission of the data received on the line 2 to the line 1 are illustrated regardless of the function installed in the MFP 100. However, a mechanism may be used in which data transmission to the network I/F is permitted for each function installed in the MFP 100. For example, a setting may be made such that transmission to the line 2 is permitted in the transmission function, but transmission of the data received on the line 1 to the line 2 is not permitted in the box function.

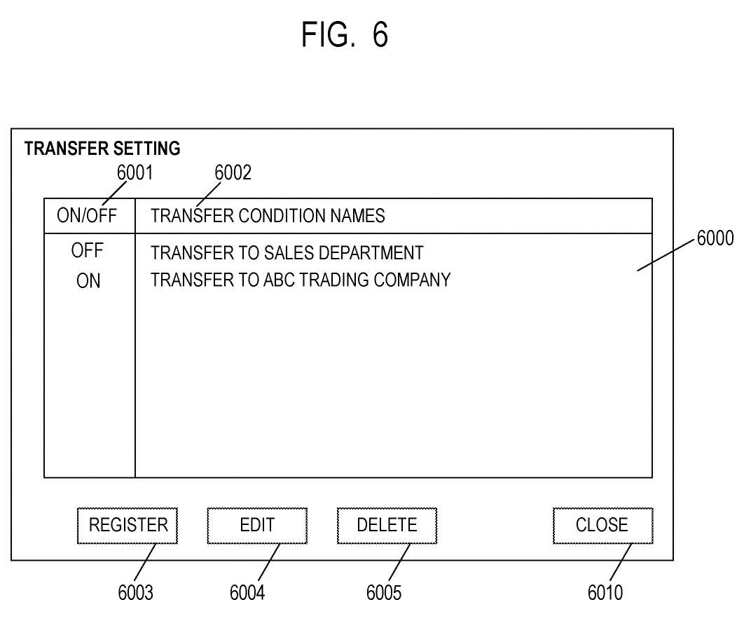

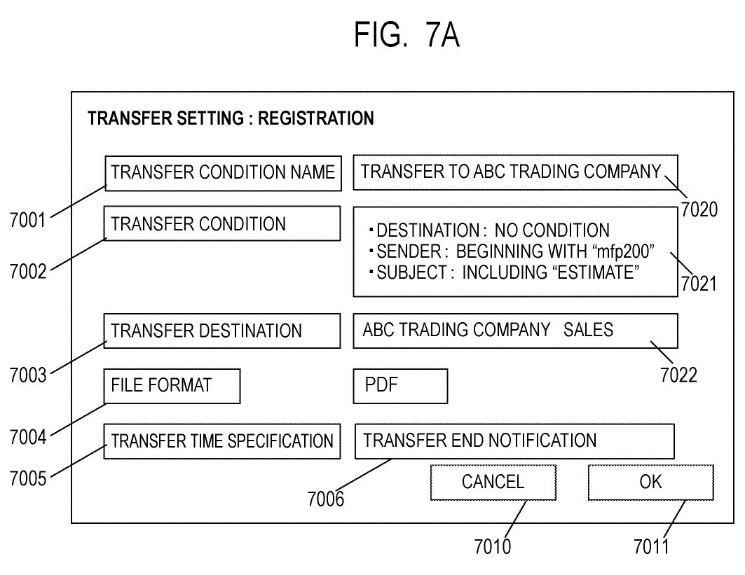

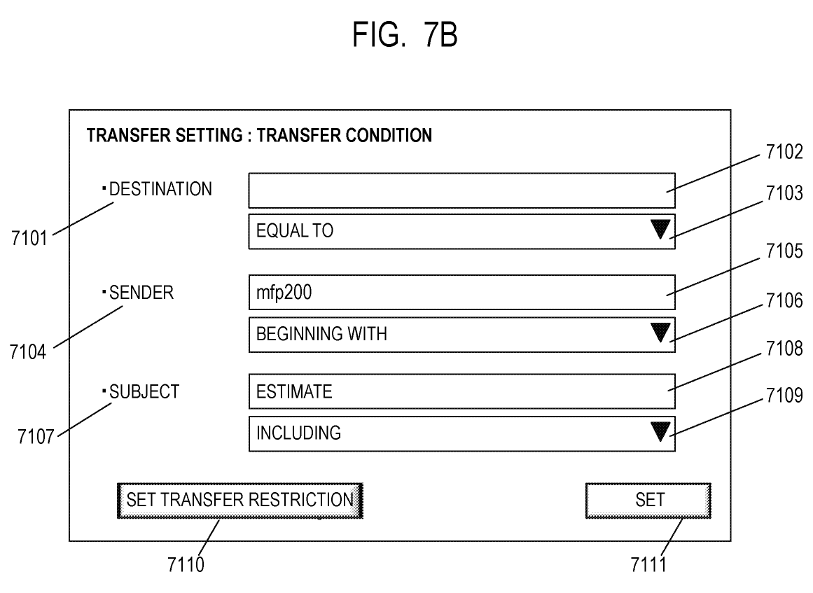

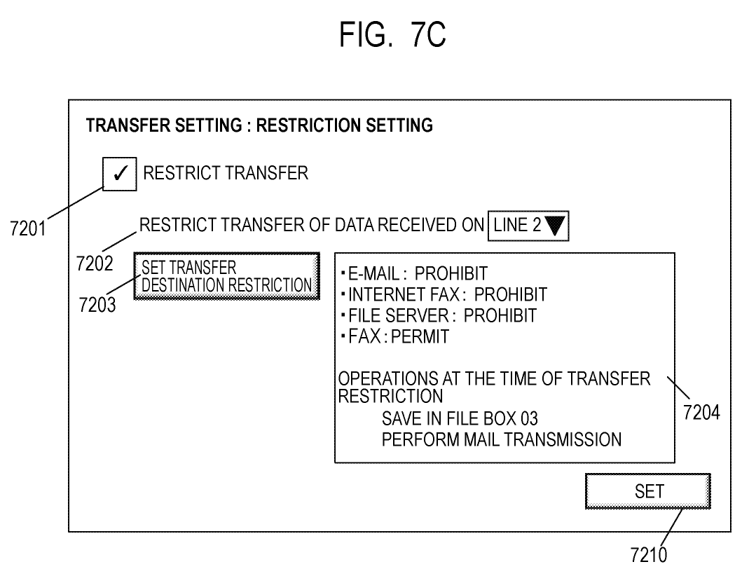

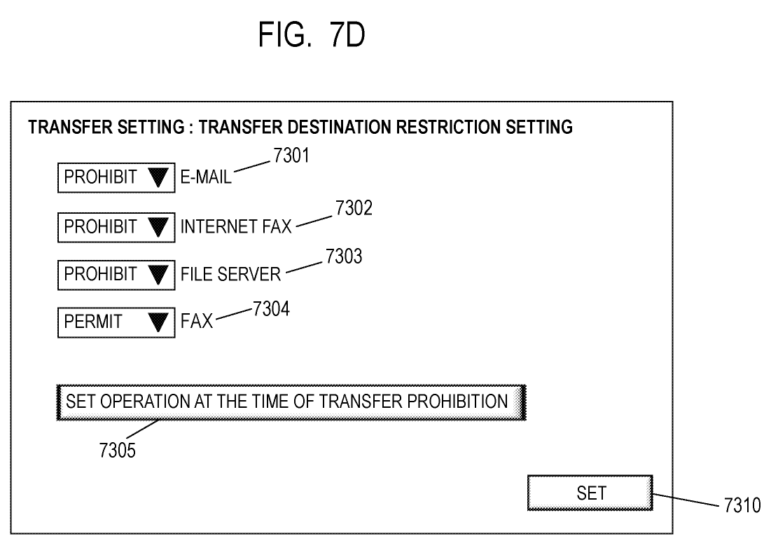

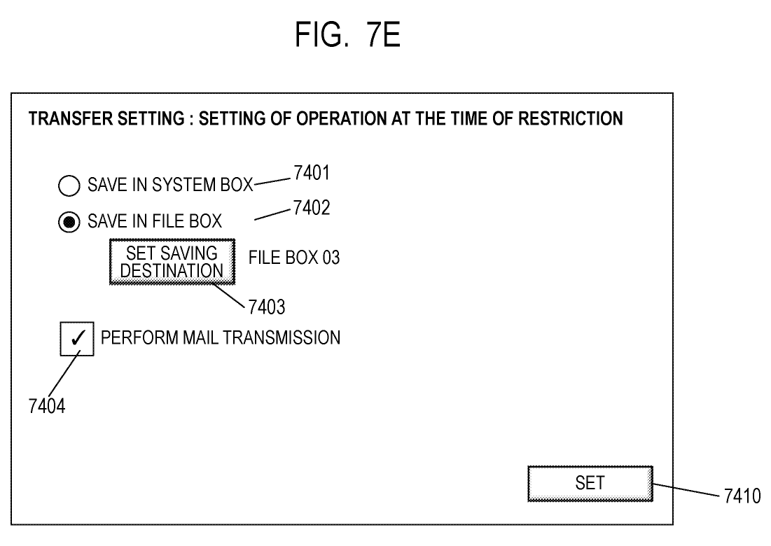

With reference to FIG. 6 and FIGS. 7A to 7E, screens displayed on the MFP 100 when the transfer setting is performed will be exemplified.

FIG. 6 is a diagram illustrating a transfer setting list screen.

In a transfer setting list 6000, a list of registered transfer settings is displayed.

A switch 6001 is an ON/OFF toggle switch, which can set whether or not to validate (ON) or invalidate (OFF) transfer for each transfer condition displayed in the transfer setting list 6000.

A display 6002 is a display of a registered transfer condition name.

In the example of FIG. 6, two transfer settings of “transfer to sales department” and “transfer to ABC trading company” are registered, and “transfer to sales department” is set to OFF and “transfer to ABC trading company” is set to ON.

A button 6003 is a new registration button, and when this button is pressed, a new transfer setting can be performed, and a basic setting screen for the transfer setting of FIG. 7A, which will be described later, is displayed.

A button 6004 is an edit button, which can be pressed in a state in which the registered transfer setting in the transfer setting list 6000 has been selected. When this button is pressed, the basic setting screen of the transfer setting of FIG. 7A is displayed in a state in which the setting of the selected transfer setting has been reflected.

A button 6005 is a delete button, which can be pressed in a state where the registered transfer setting in the transfer setting list 6000 has been selected. When this button is pressed, the setting of the selected transfer setting is deleted.

A close button 6010 is pressed to close the transfer setting screen of FIG. 6.

FIGS. 7A to 7E are diagrams illustrating the screens for performing the transfer settings. Hereinafter, FIGS. 7A to 7E may be collectively referred to as “FIG. 7”.

FIG. 7A corresponds to an example of the screen for performing the basic setting of the transfer setting, and is called from the transfer setting list screen of FIG. 6.

A button 7001 is a button for setting a transfer condition name. When the button 7001 is pressed, a keyboard (not shown) is displayed, and the name of the transfer condition can be set. The transfer condition name set here is displayed in an area 7020.

A button 7002 is a button for setting a transfer condition. When the button 7002 is pressed, a transfer setting screen of FIG. 7B, which will be described later, is displayed. The transfer conditions set here are displayed in an area 7021.

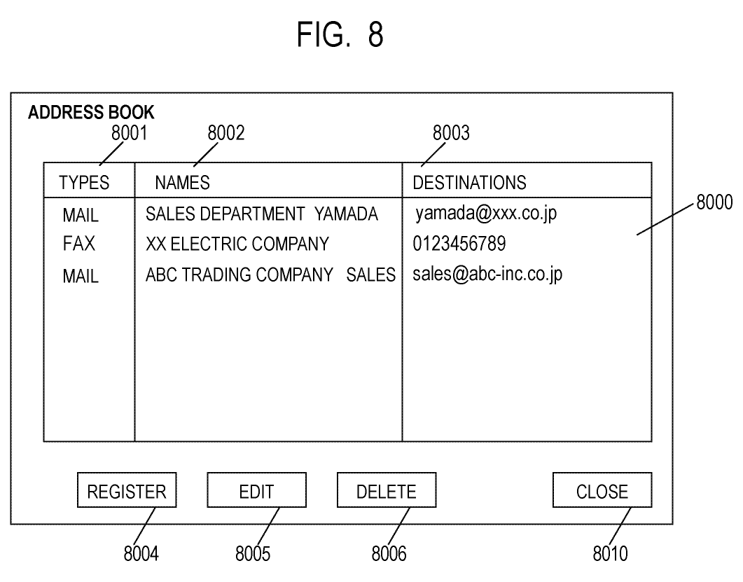

A button 7003 is a button for setting a transfer destination. When the button 7003 is pressed, an address book screen shown in FIG. 8 is displayed. The transfer destination selected on the address book screen is displayed in an area 7022. Here, the address book screen will be described with reference to FIG. 8.

FIG. 8 is a diagram illustrating the address book screen according to the first embodiment.

An area 8000 is an address book display area in which a list of registered address books is displayed. In the example of FIG. 8, three address books are displayed.

An address type is displayed in a type 8001. The address type is, for example, a protocol used for transmission of the fax, the e-mail, the Internet fax, the file server, or the like.

In a name 8002, a name registered in each of the address books is displayed.

In a destination 8003, a destination of each of the address books is displayed, and the displayed destinations correspond to the address types in the type 8001.

For example, when the type 8001 is the fax, the destination 8003 is a telephone number, and when the type 8001 is the e-mail, the destination 8003 is an e-mail address.

When a new registration button 8004 is pressed, although not shown, a screen for setting a name, a type, and a destination is displayed, and an address book can be newly created.

An edit button 8005 is used to display a screen for changing the settings of the name, the type, and the destination of the address selected in the address book display area 8000, and it is possible to change the contents of the registered address book.

A delete button 8006 is used to delete the registered address book selected in the address book display area 8000.

A close button 8010 is used to close the screen of the address book.

The address selected in the address book display area 8000 of FIG. 8 is set as the transfer destination button 7003 of FIG. 7A.

Hereinafter, the description returns to FIG. 7A. A button 7004 is a button for setting a file format. When the button 7004 is pressed, a file format to be used for transfer can be selected. When the e-mail or the file server, which is an address having a valid file format, is selected as the transfer destination button 7003, the file is transferred in the image format of the file format set in the button 7004. Examples of the file format include the TIFF and the PDF.

A button 7005 is a button for setting a transfer time. When the button 7005 is pressed, a screen (not shown) for setting a transfer execution time is displayed, and the transfer time can be set. When the transfer time has been set, the received image data is not immediately transferred after reception, and is not transferred until the time specified by the transfer time setting button 7005.

A button 7006 is a button for setting a transfer end notification. When the button 7006 is pressed, the address book selection screen of FIG. 8 is displayed, and the address of the e-mail to be transmitted when the transfer is executed can be selected. When the e-mail address of the transfer end notification has been set in the transfer time setting button 7005, the e-mail of the content of the transfer is transmitted to the set e-mail address.

A cancel button 7010 is used to end the screen of FIG. 7A without saving the transfer setting set on the screen of FIG. 7 in the Flash ROM 210.

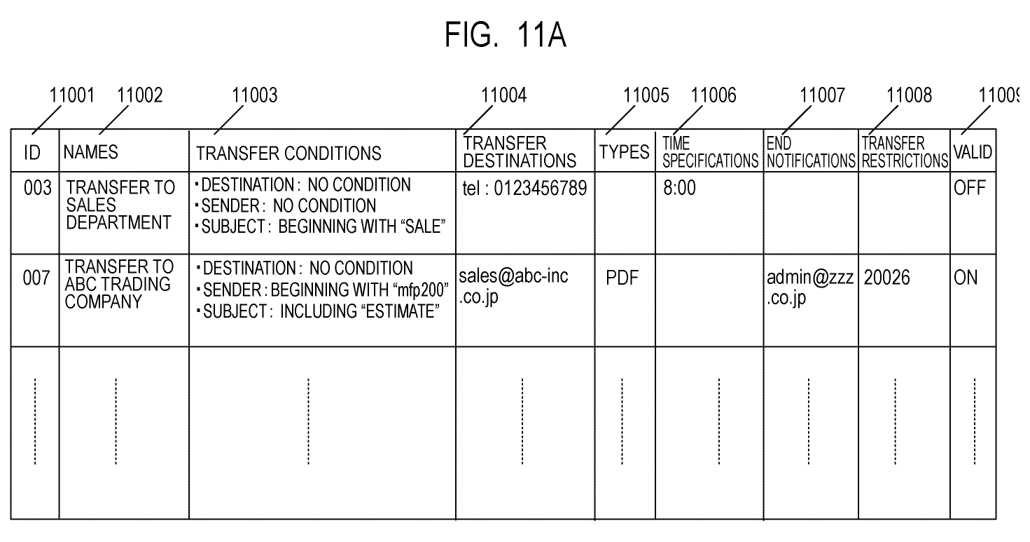

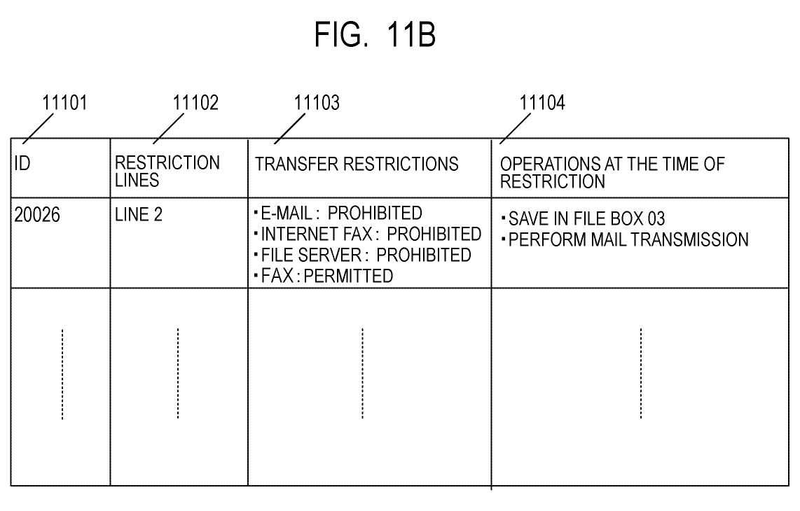

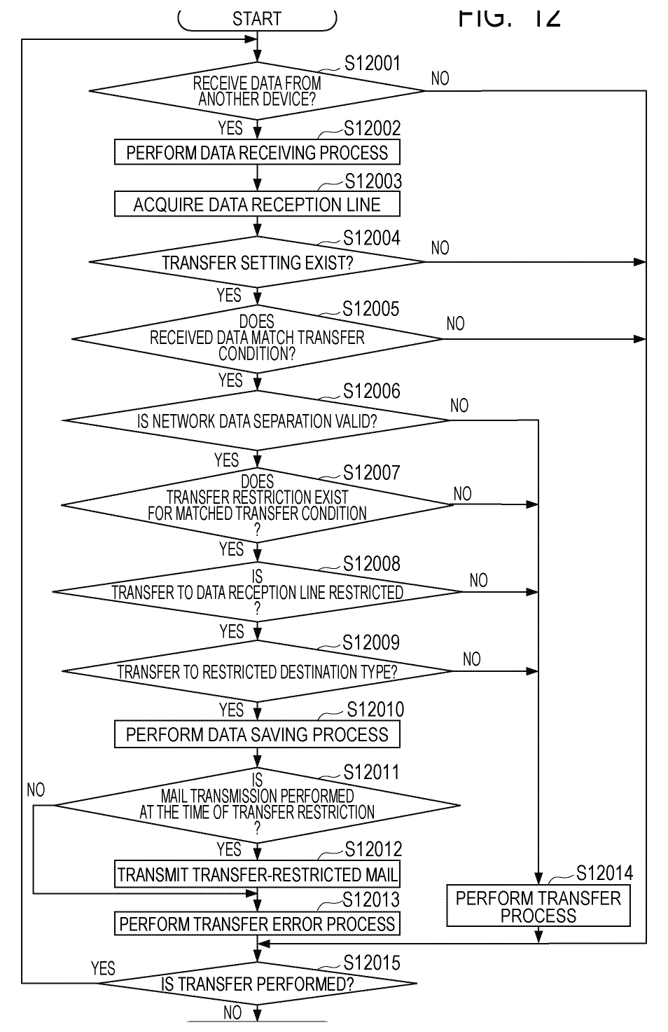

An OK button 7011 is used to save the transfer setting set on the screen of FIG. 7A in the Flash ROM 210 as shown in FIGS. 11A and 11B described later, and end the screen of FIG. 7A.

FIG. 7B corresponds to an example of the screen for setting the transfer condition, and is called from the above-described transfer condition button 7002.

A condition 7101 is a condition of the destination of the received data, which is set in accordance with the destination input in an area 7102 and the conditional expression selected in an area 7103. An example of the value set in the condition 7101 is a value described in “To header” in the case of the Internet fax. Examples of the conditional expressions of the area 7103 include “equal to”, “not equal to”, “beginning with”, “ending with”, and “including”.

For example, when “mfp100@foo.com” has been input in the area 7102 and “equal to” is selected in the area 7103, the condition is matched when the destination of the received data matches “mfp100@foo.com”. The same applies to the case where the area 7103 is “not equal to”.

When “mfp100” has been input to the area 7102 and “beginning with” is selected in the area 7103, the condition is matched when the destination of the received data starts at “mfp100”. The same applies to the case where the area 7103 is “ending with” or “including”. The conditional expression of the area 7103 is not limited to this, and may be another conditional expression.

A condition 7104 is a condition of a sender of the received data, which is set according to the destination input in an area 7105 and the conditional expression selected in an area 7106. An example of the value set in the condition 7104 is a value described

in “From header” in the case of the Internet fax. In one embodiment, the conditions 7101 and 7104 are only different between the destination and the sender, and the setting contents of the areas 7102, 7103 and 7105, 7106 are the same.

A condition 7107 is a condition of a subject of the received data, which is set according to the destination input in an area 7108 and the conditional expression selected in an area 7109. An example of the value set in the condition 7107 is a value described in “Subject header” in the case of the Internet fax. In one embodiment, the conditions 7101 and 7107 are only different between the destination and the subject, and setting contents of the areas 7102, 7103 and 7108, 7109 are the same.

In the example of FIG. 7B, there is no condition for the destination, the condition is set that the sender is beginning from “mfp200”, and the condition is set that the subject includes “estimate”.

A button 7110 is a button for setting a transfer restriction (restriction information for restricting transfer). When the button 7110 is pressed, a transfer restriction setting screen of FIG. 7C, which will be described later, is displayed. Note that the button 7110 is displayed only when it is checked that network data separation is to be performed on the screen of FIG. 5A for setting whether or not to perform the network data separation.

A setting button 7111 is used to set the transfer condition input in FIG. 7B and return to the screen of FIG. 7A.

FIG. 7C corresponds to an example of the screen for setting the transfer restriction, and is called from the button 7110 in FIG. 7B.

A check box 7201 is a check box for setting the transfer restriction, and ON (checked) and OFF (not checked) can be set by toggling. When the check box 7201 is set to ON (transfer restriction is performed), settings 7202 and 7203 can be performed. When the check box 7201 is set to OFF (transfer restriction is not performed), the settings 7202 and 7203 cannot be performed.

The setting 7202 is selection of the line of the network I/F that restricts transfer of the received data, and it is possible to select the line 1 or the line 2. In the embodiment, the two lines are selected, but in the case of a device having three or more lines, the restriction of transfer may be set for each line.

The setting 7203 corresponds to a button for setting the destination type of a destination restriction for setting a type of the destination to be restricted as a transfer destination of the line selected in the setting 7202. When the button 7203 is pressed, a destination type setting screen for transfer destination restriction shown in FIG. 7D, which will be described later, is displayed.

The type of the destination to be restricted as the transfer destination set in the button 7203 and an operation setting when the transfer is restricted are displayed in an area 7204.

A button 7210 is a setting button, which is used to set the transfer restriction input in FIG. 7C and return to the screen of FIG. 7B.

FIG. 7D corresponds to an example of the screen for setting the type of destination to be restricted as the transfer destination, and is called from the above-described setting 7203.

In a setting 7301, whether to permit or prohibit the e-mail is set as the destination type of the transfer destination.

In a setting 7302, whether to permit or prohibit the Internet fax is set as the destination type of the transfer destination.

In a setting 7303, whether to permit or prohibit the file server is set as the destination type of the transfer destination. In the example of FIG. 7D, whether to permit or prohibit the file server is set as the destination type of the transfer destination, but whether to permit or prohibit the file server may be set for each protocol such as the SMB or the FTP.

In a setting 7304, whether to permit or prohibit the fax is set as the destination type of the transfer destination.

A button 7305 is used to set an operation when the reception/transfer is prohibited. When the button 7305 is pressed, a transfer prohibition operation setting screen shown in FIG. 7E, which will be described later, is displayed.

A button 7310 is a setting button, which is used to set the type of the destination to be restricted as the transfer destination input in FIG. 7D and return to the screen of FIG. 7C.

FIG. 7E corresponds to an example of the screen for performing the operation setting in a case where the reception/transfer is restricted, and is called from the button 7305 of FIG. 7D.

Radio buttons 7401 and 7402 are used for the operation setting when the reception/transfer is restricted and is not performed, and one of them can be selected.

The radio button 7401 is for setting the received data to be saved in the system box when the transfer is restricted and not performed.

The radio button 7402 is for setting the received data to be saved in the fax box when the transfer is restricted and not performed.

In a case where the saving in the fax box is set by the radio button 7402, a box of the saving destination can be further set by a button 7403, and the number of the designated file box is displayed. In the case of the saving in the fax box, by specifying the fax box to which the personal identification number has been set, it is possible to protect the reference of the received data to which the transfer is prohibited.

A check box 7404 is used to set whether or not to transmit the mail in the case where the reception/transfer is restricted. When the check box 7404 is checked, the transfer end notification of the button 7006 of FIG. 7A is ON in conjunction with the check box. At this time, when the mail address of the e-mail serving as a notification destination of the transfer end notification is not set in the button 7006, a screen for setting the mail address of the e-mail may be displayed to prompt the user to set the mail address.

A button 7410 is a setting button, which is used to set the operation when the transfer that is input in FIG. 7E is restricted, and return to the screen of FIG. 7D.

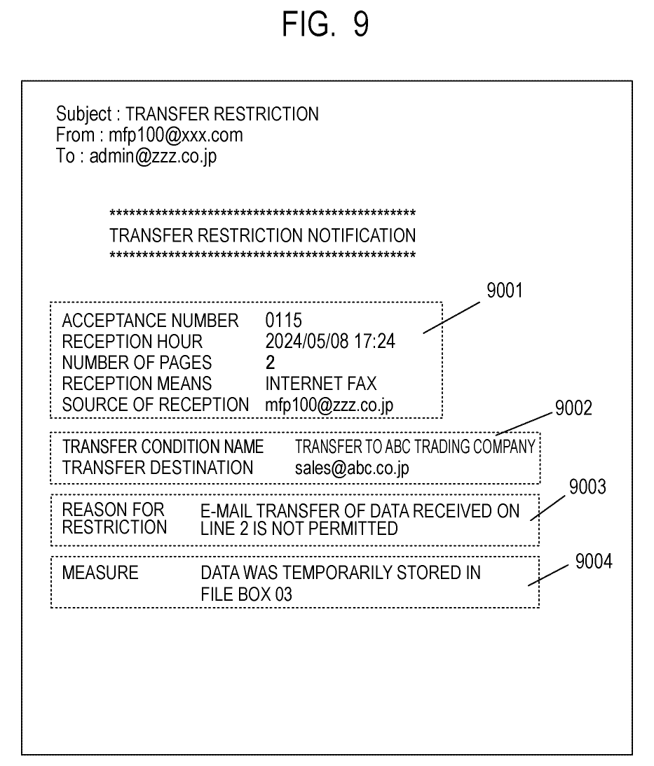

FIG. 9 is a diagram illustrating an example of the e-mail to be transmitted when the e-mail is set to be transmitted in the case where the reception/transfer is restricted in the check box 7404.

An area 9001 indicates the contents of the received data. In the example of FIG. 9, the acceptance number is “0115”, the reception hour is “2024/05/08 17:24”, the number of pages of the received data is “2”, the reception means is “Internet fax”, and the source of reception of the received data is “mfp100@zzz.co.jp”.

An area 9002 indicates the transfer condition in which the transfer is restricted. In the example of FIG. 9, the transfer condition name is “transfer to ABC trading company”, and the transfer destination is “salse@abc.co.jp”.

An area 9003 indicates the reason why the transfer has been restricted and not performed.

An area 9004 indicates a storage location of the received data that has not been transferred.

FIG. 10 is a diagram illustrating an example of a data structure for recording the setting of the network data separation according to the embodiment.

The network data separation control section 409 acquires the settings of FIGS. 5A and 5B by using the operation control section 401, and saves them in the Flash ROM 210 as shown in FIG. 10.

The setting 10001 is a setting as to whether or not to perform the network data separation, and is ON when the button 5001 of FIG. 5A is checked, and is OFF when the button 5002 is checked.

The setting 10002 is a setting value indicating whether or not the data received on the line 1 is permitted to be transmitted to the line 2, and is set in accordance with the setting 5101 in FIG. 5B.

The setting 10003 is a setting value indicating whether or not the data received on the line 2 is permitted to be transmitted to the line 1, and is set in accordance with the setting 5102 in FIG. 5B.

FIGS. 11A and 11B are diagrams illustrating an example of a data structure for recording the transfer settings in the embodiment.

The transfer control section 410 acquires the settings of FIG. 7 using the operation control section 401, and saves the acquired settings in the Flash ROM 210 as shown in FIGS. 11A and 11B.

FIG. 11A corresponds to an example of the data structure of the transfer setting.

A transfer condition ID 11001 is a transfer condition ID that uniquely determines the transfer condition inside the MFP 100. The transfer condition ID is issued in the MFP 100 when a new transfer condition is registered.

A name 11002 indicates the setting value of the transfer condition name, and the name that is set in the button 7001 of FIG. 7A is recorded.

In the setting of a transfer condition 11003, the values of the transfer condition set in FIG. 7B are stored.

In the setting of a transfer destination 11004, the destination selected in the button 7003 of FIG. 7A is recorded as the setting value.

In the setting of a file format type 11005, the file format selected in the button 7004 of FIG. 7A is recorded as the setting value. When the file is not transferred because the transfer destination is the fax or the like, this setting is blank.

In the setting of a time specification 11006, the transfer time set in the button 7005 of FIG. 7A is recorded as the setting value. When the transfer time is not set, the time specification 11006 is blank.

In the setting of an end notification 11007, the transfer end notification is set. The mail address selected on the button 7006 of FIG. 7A is set. When the transfer end notification is not performed, the end notification 11007 is blank.

In the setting of a transfer restriction 11008, the transfer restriction is set. When the transfer restriction is performed, a transfer restriction ID described later with reference to FIG. 11B is recorded in the transfer restriction 11008. When the transfer restriction is not performed, the transfer restriction 11008 is blank.

A setting 11009 indicates the setting as to whether or not the transfer condition is validated, which is set by the switch 6001 of FIG. 6, and ON is set when the transfer condition is valid, and OFF is set when the transfer condition is invalid. In the embodiment, when the transfer condition is registered, it is set to be valid (ON).

FIG. 11B corresponds to an example of the data structure of the transfer restriction setting.

A transfer restriction ID 11101 uniquely determines the transfer restriction in the MFP 100. The transfer restriction ID is issued in the MFP 100 when a new transfer restriction is registered. Note that the transfer restriction ID 11101 corresponds to the data structure of the transfer restriction 11008 of the transfer setting of FIG. 11A.

In the setting of a restriction line 11102, the line for which the transfer is restricted in the setting 7202 of FIG. 7C is recorded.

In the setting of a transfer restriction 11103, the transfer restriction is set. The contents set in the settings 7301, 7302, 7303 and 7304 of FIG. 7D are recorded therein.

In the setting of operation at the time of transfer restriction 11104, the contents set in the buttons 7401, 7402, 7403 and the check box 7404 of FIG. 7E are recorded.

FIG. 12 is a flowchart illustrating an example of the process to be executed when the MFP 100 according to the first embodiment receives the data from another device and executes the transfer function. The process of this flowchart is realized by the CPU 201 of the MFP 100 in FIG. 12 reading a program saved in the Flash ROM 211 into the DRAM 202 and executing the read program.

When the MFP 100 is activated, the process of this flowchart is started.

In S12001, the MFP 100 confirms whether or not the data has been received from another device. Specifically, the network control section 407 monitors the network I/Fs 220 and 221 and confirms the data reception.

Here, when the data has not been received from another device (NO in S12001), the MFP 100 advances the process to S12015. The process in S12015 will be described later.

On the other hand, when the data is received from another device (YES in S12001), the MFP 100 advances the process to S12002.

In S12002, the network control section 407 performs a data receiving process. Since the data receiving process is not the essence of the disclosure, detailed description thereof will be omitted.

In S12003, the transfer control section 410 confirms the network control section 407 to acquire which line the data received in S12002 is received from.

In S12004, the transfer control section 410 determines whether or not a transfer setting exists. Specifically, the transfer control section 410 confirms whether or not the transfer setting as shown in FIG. 11A exists.

When there is no transfer setting (NO in S12004), the transfer control section 410 advances the process to S12015 because the transfer process is not executed.

On the other hand, when there is the transfer setting (YES in S12004), the transfer control section 410 advances the process to S12005.

In S12005, the transfer control section 410 determines whether or not the data received in S12002 matches the transfer condition. Specifically, the transfer control section 410 acquires the destination, the sender, and the subject from the network control section 407. Further, the transfer control section 410 confirms whether or not the acquired destination, sender, and subject match the settings of the transfer condition stored in the transfer condition 11003 of FIG. 11A.

Here, in a case where there is no matched one (NO in S1205), the transfer control section 410 determines that it is not necessary to perform the transfer, and advances the process to S12015 because the transfer process is not executed.

On the other hand, when there is a match (YES in S1205), the transfer control section 410 determines that the transfer is necessary, and the process advances to S12006.

Note that in the embodiment, the transfer destination conditions are the destination, the sender, and the subject, but other conditions may be used, and in such a case, information necessary for other conditions is acquired and determined.

In S12006, the transfer control section 410 determines whether or not the network data separation is valid. The transfer control section 410 confirms to the network data separation control section 409 whether the network data separation setting such as the setting 10001 in FIG. 10 is ON or OFF.

Here, when the network data separation setting is OFF, the transfer control section 410 determines that the network data separation is invalid (determines NO in S12006). Thus, since the transfer can be executed, the process advances to S12014. The process in S12014 will be described later.

On the other hand, when the network data separation setting is ON, the transfer control section 410 determines that the network data separation is valid (YES in S12006), and advances the process to S12007.

In S12007, the transfer control section 410 determines whether or not the transfer is restricted with respect to the transfer condition matched in S12005. Specifically, the transfer control section 410 confirms whether or not the transfer restriction ID of the transfer restriction setting as shown in FIG. 11B is set in the transfer restriction 1108 of the matched transfer condition.

Here, in a case where the transfer restriction ID is not set, the transfer control section 410 determines that the transfer restriction setting does not exist (NO in S12007), and advances the process to S12014 because the transfer is possible.

On the other hand, when the transfer restriction ID is set, the transfer control section 410 determines that the transfer restriction setting exists (YES in S12007), and advances the process to S12008.

In S12008, the transfer control section 410 determines whether or not the transfer of the data received in S12002 to the data reception line is restricted. Specifically, the transfer control section 410 confirms whether or not the data reception line acquired in S12003 matches the restriction line (the restriction line such as the restriction line 11102 in FIG. 11B) of the transfer restriction setting for the matched transfer setting.

Here, when the lines do not match, the transfer control section 410 determines that the transfer is not restricted (NO in S12008), and advances the process to S12014.

On the other hand, when the lines match, the transfer control section 410 determines that the transfer is restricted (YES in S12008), and advances the process to S12009.

In S12009, the transfer control section 410 determines whether or not the transfer is performed to the destination type restricted as the transfer destination. Specifically, the transfer control section 410 determines whether the destination type such as the transfer destination 11004 in FIG. 11A, which is the transfer destination of the transfer condition matched in S12005, is the destination type permitted or prohibited to be transferred in the transfer restriction 11103 set as the transfer restriction. For example, when the destination type of the transfer destination of the transfer condition is “e-mail,” it is confirmed whether or not the e-mail is permitted or prohibited by the transfer restriction such as the transfer restriction 11103 in FIG. 11A.

Here, when the destination type of the transfer destination is permitted by the transfer restriction, the transfer control section 410 determines that the transfer is not the transfer to the restricted destination type (NO in S12009), and advances the process to S12014 because the transfer is possible.

On the other hand, when the destination type of the transfer destination is prohibited by the transfer restriction, the transfer control section 410 determines that the transfer is the transfer to the restricted destination type (YES in S12009), and advances the process to S12010.

In S12010, the transfer control section 410 saves the received data as an error process because the transfer is restricted. Specifically, the transfer control section 410 determines whether or not the saving destination is the system box or the fax box by setting a transfer restriction operation such as the setting 11104 in FIG. 11B, and instructs the data storage section 402 to save the received data. Although the saving destination is the system box or the fax box in the embodiment, the saving destination may be another saving destination such as an external file server, or may be printed or transmitted to the administrator by an e-mail.

Next, in S12011, the transfer control section 410 determines whether or not to transmit the mail at the time of the transfer restriction. Specifically, the transfer control section 410 determines whether or not the mail address is set in the setting of the transfer restriction operation such as the setting 11104 in FIG. 11B.

When the mail address is not set, the transfer control section 410 determines that the mail is not to be transmitted at the time of the transfer restriction (NO in S12011), and the process advances to S12013.

Here, when the mail address is set, the transfer control section 410 determines that the mail is to be transmitted at the time of the transfer restriction (YES in S12011), and the process advances to S12012.

In S12012, the transfer control section 410 transmits, to the predetermined notification destination, the mail having the content that could not be transferred due to the transfer restriction. Specifically, the transfer control section 410 transmits the e-mail having the content illustrated in FIG. 9 to the e-mail address (the notification destination of the transfer end notification set in the button 7006 of FIG. 7A) described in the setting of the transfer restriction operation such as the setting 11104 of FIG. 11B. The e-mail transmission is a well-known technique and is not the essence of the disclosure, and thus description thereof will be omitted. After transmitting the e-mail, the transfer control section 410 advances the process to S12013.

In S12013, the transfer control section 410 performs a transfer error process other than the above-described processes in S12010 and S12012. After the execution of the transfer error process, the transfer control section 410 advances the process to S12015.

In S12014, the transfer control section 410 performs the transfer process of the data received in S12002. Specifically, the transfer control section 410 converts the data received in S12002 into a file format such as the type 11005 in FIG. 11A and transmits the converted data to a transfer destination such as the transfer destination 11004 in the transfer setting of FIG. 11A. After the data transmission, the transfer control section 410 advances the process to S12015.

In S12015, the transfer control section 410 determines whether or not to execute the transfer process in the embodiment. Specifically, the transfer control section 410 confirms whether or not the transfer setting is registered in the data of the transfer setting as shown in FIG. 11A and there is valid in the setting 11009.

Here, when the transfer setting is registered in the data of the transfer setting in FIG. 11A and there is valid in the setting 11009 (YES in S12015), the transfer control section 410 returns the process to S12001 and waits for reception of the next data.

On the other hand, when the transfer setting is not registered in the data of the transfer setting in FIG. 11A, or when there is no valid in the setting 11009, the transfer control section 410 ends the process of this flowchart because there is no setting to be transferred.

In the transfer setting, the process of this flowchart is resumed when the setting 11009 in FIG. 11A becomes valid.

Although the example in which the restriction is performed according to the transfer restriction condition set in the transfer setting is illustrated here, the restriction may also be performed according to the restriction illustrated in FIG. 5B.

According to the above process, in the MFP connected to the plurality of lines, when the received data is transferred, the transfer can be prohibited according to the reception line and the destination of the transfer destination. As a result, it is possible to suppress occurrence of a situation in which data is transmitted to a transmission prohibited line via the gateway. That is, it is possible to suppress unintended data transfer among the plurality of lines.

In the settings of the transfer restriction (the settings 7301, 7302, 7303 and 7304 in FIG. 7D, and the transfer restriction 11103 in FIG. 11B) in the above embodiment, the transfer permission/prohibition is set for each destination type.

However, a configuration may be adopted in which only the type of the destination to which the transfer is permitted is set, and the type of the destination to which the transfer permission is not set is regarded as the destination to which the transfer prohibition is set. Besides, a configuration may be adopted in which only the type of the destination to which the transfer is prohibited is set, and the type of the destination to which the transfer prohibition is not set is regarded as the destination to which the transfer permission is set. For example, at least one of the type of the destination to which the transfer is permitted and the type of the destination to which the transfer is prohibited may be set.

That is, it is sufficient that the type of the destination to which the transfer is permitted and the type of the destination to which the transfer is prohibited can be specified.

### Second Embodiment

In the first embodiment, the destination of the transfer destination is a single destination, but in the embodiment, an example will be described in which a group destination including a plurality of destinations is set as the destination of the transfer destination.

The group destination is a group of a plurality of destinations such as an e-mail, a file server and the like, for example. When transmission is performed to the group destination, the transmission to all the destinations included in the group destination is executed.

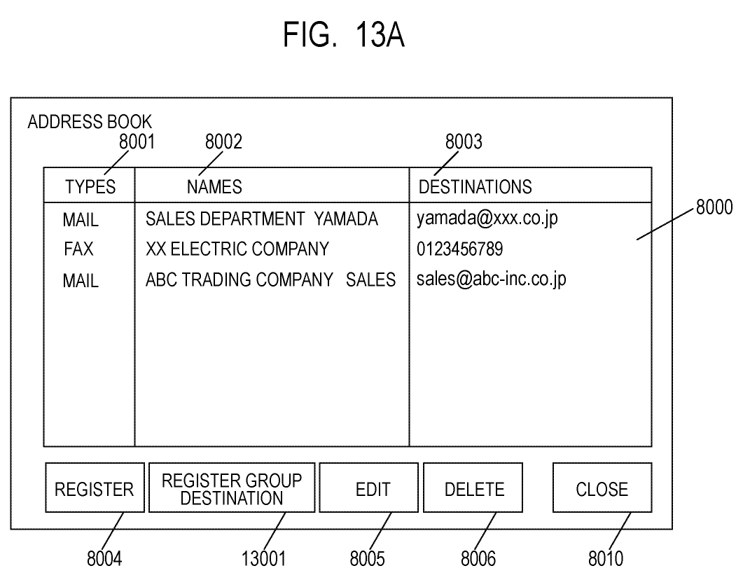

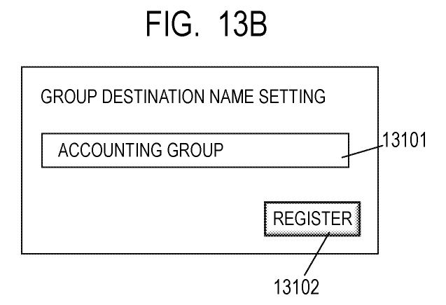

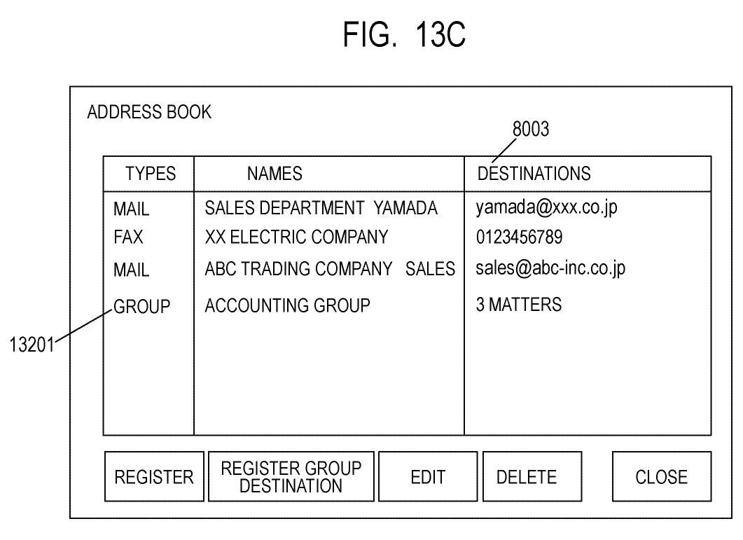

FIGS. 13A to 13C are diagrams illustrating screens of an address book according to the second embodiment, which is a screen of the address book corresponding to the group destination.

FIG. 13A corresponds to an example of an address book screen. In FIG. 13A, the same parts as those in FIG. 8 are denoted by the same reference numerals respectively, and descriptions thereof will be omitted.

A button 13001 is a group destination registration button. When a plurality of destinations of the address book are selected in the address book display area 8000 and the button 13001 is pressed, a group destination name setting screen shown in FIG. 13B is displayed.

FIG. 13B corresponds to an example of the group destination name setting screen.

A group destination name is input to an area 13101. A button 13102 is a registration button for determining the group destination name.

FIG. 13C corresponds to an example of the address book screen in which the group destination is registered.

A destination 13201 indicates a registered group destination. In the case of the group destination, the number of destinations registered in the group is displayed in the destination 8003. In the case of an accounting group illustrated in FIG. 13C, “3” is displayed.

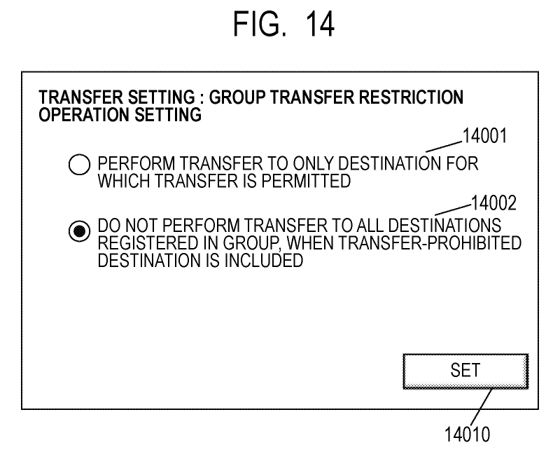

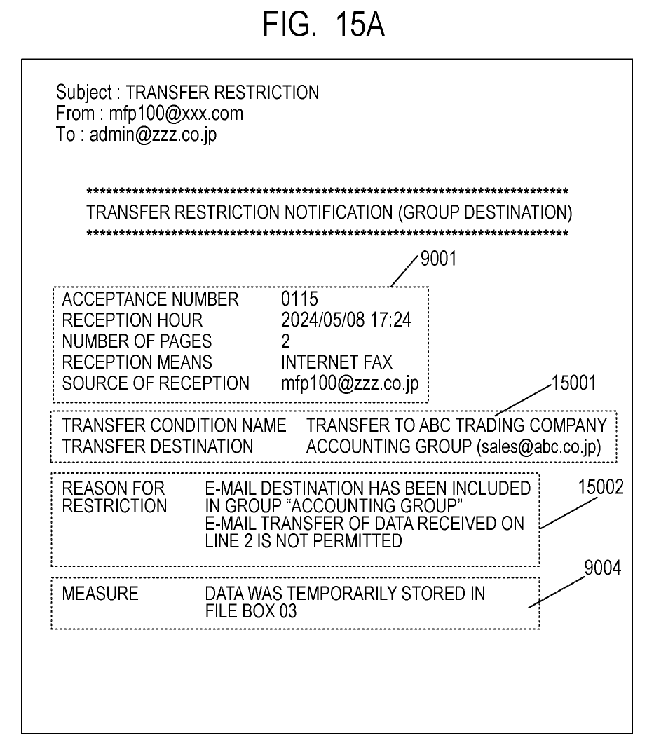

FIG. 14 is a diagram illustrating an example of a screen for setting an operation to be performed when the group destination is set as the transfer destination and there is the transfer restriction in the second embodiment.

Since the plurality of types of destinations can be registered as the group destination, for example, the e-mail and the fax can be registered as one group. In this case, when the transfer destination restriction setting as shown in FIG. 7D has been set, the e-mail is prohibited (the setting 7301) and the fax is permitted (the setting 7304).

In this way, the setting for determining how to perform the transfer of the group destination is the group transfer restriction operation setting shown in FIG. 14 in the case where the destinations registered as the group destinations include both the destinations for which the transfer is permitted and the destinations for which the transfer is prohibited.

In FIG. 14, radio buttons 14001 and 14002 are used to select the group transfer restriction operation, and one of them can be selected.

In one embodiment, the button 14001 is a button to be selected when the transfer is performed only to the destination for which the transfer is permitted among the destinations registered in the group destination. When the button 14001 is selected, in the case of the setting example in FIG. 7D, only the fax transfer is executed in the group in which the e-mail and the fax are registered.

The button 14002 is a button to be selected when the transfer to all the destinations registered in the group destination is not performed in a case where even one of the destinations registered in the group destination is prohibited. When the button 14002 is selected, in the setting example in FIG. 7D, since the transfer of the e-mail is prohibited in the group in which the e-mail and the fax are registered, also the transfer of the fax registered in the same group destination is not performed.

A setting button 14010 is used to determine the group transfer restriction operation setting that is input in FIG. 14.

Although not shown, the screen of FIG. 14 is called from a screen for setting the system environment of the MFP 100 by the administrator of the MFP 100.

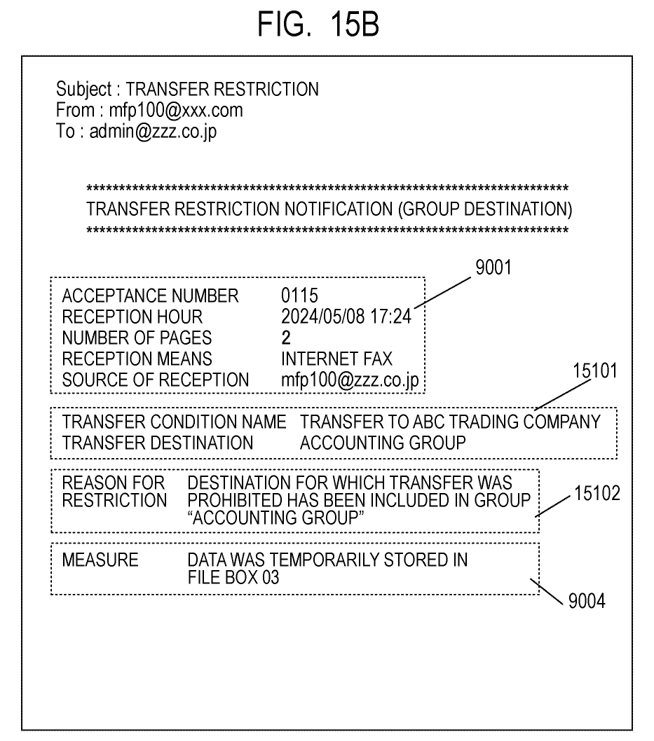

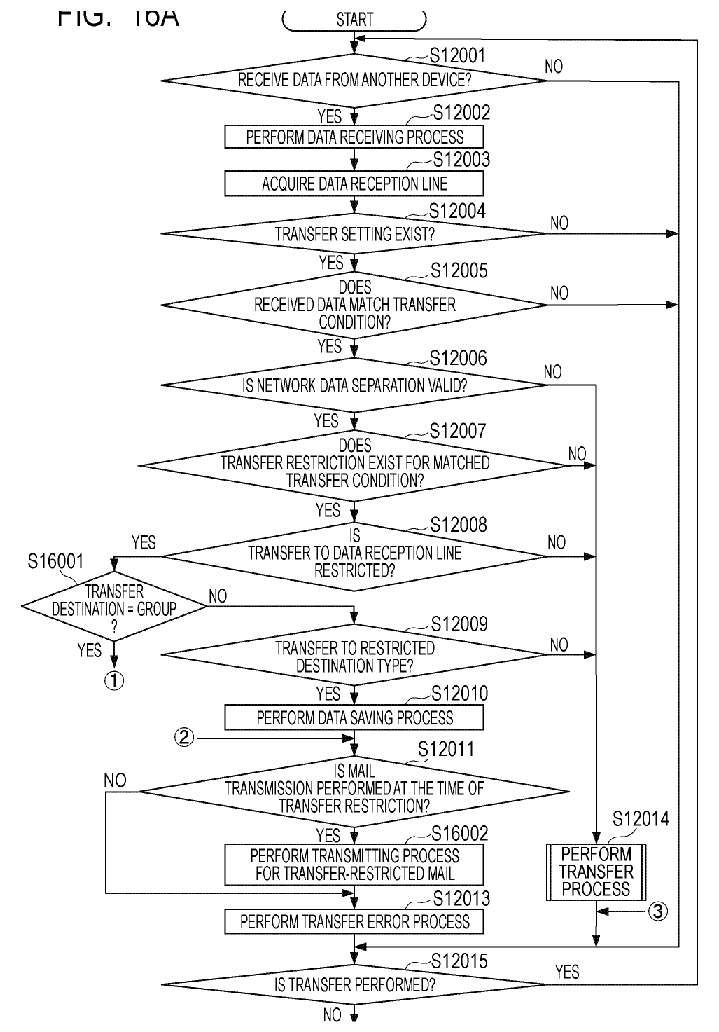

FIGS. 15A and 15B are diagrams illustrating examples of the e-mails to be transmitted when the transfer to the group destination is restricted.

FIG. 15A corresponds to the example of the e-mail in a case where the button 14001 in FIG. 14 is selected and the transfer is performed only to the destination to which the transfer of the group destination is permitted. The same parts as those in FIG. 9 are denoted by the same reference numerals respectively.

In an area 15001, a name of the group destination (accounting group) and a destination (sales@abc.co.jp) to which the transfer is restricted are output as the transfer destination.

The reason why the data cannot be transferred with the group destination is described in an area 15002.

FIG. 15B corresponds to the example of the e-mail in a case where the button 14002 in FIG. 14 is selected and, when the group destination includes the destination to which the transfer is prohibited, the transfer to all the destinations is not performed. The same parts as those in FIG. 9 are denoted by the same reference numerals respectively.

In an area 15101, a name (accounting group) of the group destination is output as the transfer destination.

The reason why the data cannot be transferred with the group destination is described in an area 15102.

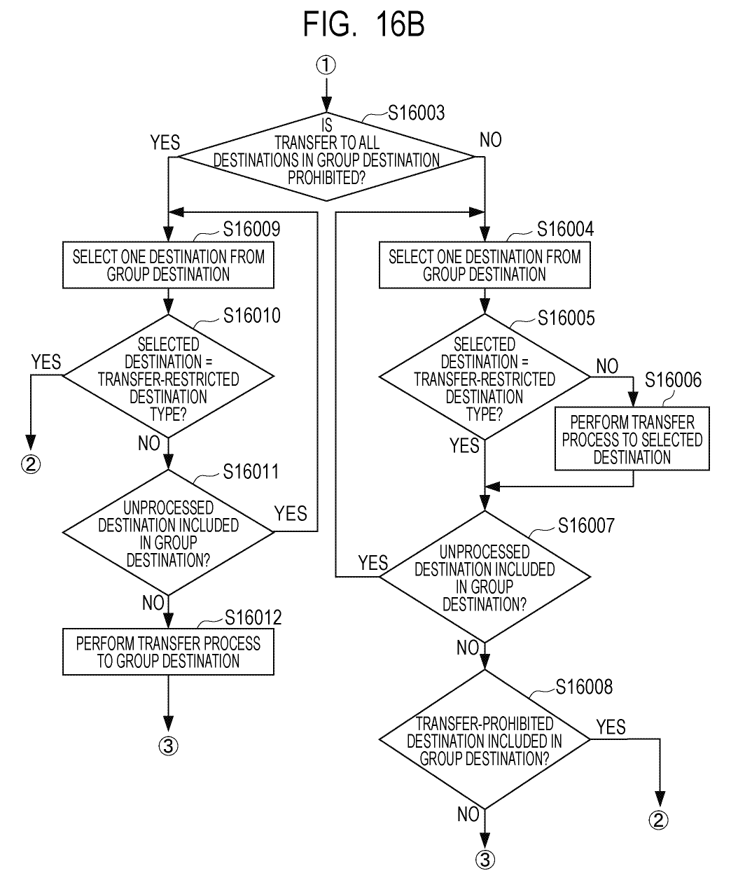

FIGS. 16A and 16B are flowcharts illustrating an example of a process to be executed when the MFP 100 according to the second embodiment receives data from another device and executes the transfer function. The process of the flowcharts is realized by the CPU 201 of the MFP 100 in FIG. 12 reading a program saved in the Flash ROM 211 into the DRAM 202 and executing the read program.

When the MFP 100 is activated, the process of the flowcharts is started. In FIG. 16A, the same steps as those in FIG. 12 are denoted by the same step numbers respectively, and the description thereof will be omitted.

In the second embodiment, when the transfer control section 410 determines that the transfer of the data received in S12002 to the data reception line is restricted (YES in S12008), the process advances to S16001.

In S16001, the transfer control section 410 determines whether or not the group destination is set as a destination of the transfer destination. Specifically, the transfer control section 410 confirms whether or not the transfer destination 11004 in FIG. 11A, which is the transfer destination of the transfer condition matched in S12005, is the group destination.

When it is determined that the destination is not the group destination (NO in S16001), the transfer control section 410 advances the process to S12009.

On the other hand, when it is determined that the destination is the group destination (YES in S16001), the transfer control section 410 advances the process to S16003 because it is necessary to confirm each destination registered in the group destination.

In S16003, the transfer control section 410 determines whether or not the transfer to all the destinations in the group destination is prohibited. Specifically, the transfer control section 410 confirms and determines the group transfer restriction operation setting in FIG. 14.

Here, in one embodiment, when the button 14001 in FIG. 14 is selected, the transfer is performed only to the destination to which the transfer is permitted. Therefore, the transfer control section 410 determines that the transfer to all the destinations in the group destination is not prohibited (NO in S16003), and advances the process to S16004.

On the other hand, when the button 14002 in FIG. 14 is selected, the transfer to all the destinations registered in the group destination is prohibited when the transfer to even one of the destinations in the group destination is prohibited. Therefore, the transfer control section 410 determines that the transfer to all destinations in the group destination is prohibited (YES in S16003), and advances the process to S16009.

In S16004, the transfer control section 410 selects one unprocessed destination from the group destination of the transfer destinations. Specifically, the transfer control section 410 selects the destination that has not been processed from among the destinations that are in the transfer destination 11004 of FIG. 11A and have been registered as the group destination.

In S16005, the transfer control section 410 determines whether or not the destination type selected in S16003 is the destination type to be restricted as the transfer destination. Specifically, the transfer control section 410 determines whether or not the type of the destination selected in S16003 is prohibited from being transferred in the transfer restriction 11103 of FIG. 11B set as the transfer restriction.

Here, when the transfer is prohibited (YES in S16005), the transfer control section 410 advances the process to S16007 to confirm another destination registered in the group destination.

On the other hand, when the transfer is not prohibited (NO in S16005), the transfer control section 410 advances the process to S16006 to perform the transfer to the destination selected in S16004.

In S16006, the transfer control section 410 performs the transfer to the destination selected in S16004. This process is equivalent to the process in S12014. Upon completion of the transfer process in S16004, the transfer control section 410 advances the process to S16007 to confirm another destination registered in the group destination.

In S16007, the transfer control section 410 determines whether or not an unprocessed destination is included in the group destination of the transfer destinations. Specifically, the transfer control section 410 confirms whether or not there is a destination not selected in S16004 among the destinations registered in the group destination of the transfer destinations.

Here, when there is the destination that has not yet been selected (unprocessed destination) (YES in S16007), the transfer control section 410 returns the process to S16004 because it is necessary to confirm whether or not the transfer is permitted for the type of the unprocessed destination.

On the other hand, when there is no destination (unprocessed destination) that has not been selected (NO in S16007), the transfer control section 410 advances the process to S16008 because the transfer control section 410 has confirmed the transfer restriction for all the destinations registered in the group destination.

In S16008, the transfer control section 410 confirms whether or not the destinations registered in the group destination include the transfer-prohibited destination. Specifically, the transfer control section 410 confirms whether or not there is the case of YES in S16005.

Here, when the destinations registered in the group destination include the transfer-prohibited destination (in case of YES in S16008), the transfer control section 410 advances the process to S12011.

On the other hand, when the destinations registered in the group destination do not include the transfer-prohibited destination (in case of NO in S16008), the transfer control section 410 advances the process to S12015.

In S16009, the transfer control section 410 selects one unprocessed destination from the group destination of the transfer destinations. Specifically, the transfer control section 410 selects the destination that has not been processed from among the destinations that are in the transfer destination 11004 and have been registered in the group destination.

In S16010, the transfer control section 410 determines whether or not the destination type selected in S16009 is the destination type to be restricted as the transfer destination. Specifically, the transfer control section 410 determines whether or not the type of the destination selected in S16009 is prohibited from being transferred in the transfer restriction 11103 of FIG. 11B set as the transfer restriction.

Here, when the transfer is prohibited (YES in S16010), the transfer control section 410 advances the process to S12011.

On the other hand, when the transfer is not prohibited (NO in S16010), the transfer control section 410 advances the process to S16011 to perform the transfer to the destination selected in S16004.

In S16011, the transfer control section 410 determines whether or not an unprocessed destination is included in the group destination of the transfer destinations. Specifically, the transfer control section 410 confirms whether or not there is a destination not selected in S16009 among destinations registered in the group destination of the transfer destinations.

Here, when there is the destination (unprocessed destination) that has not yet been selected (YES in S16011), the transfer control section 410 returns the process to S16009 because it is necessary to confirm whether or not the transfer can be performed for the unprocessed destination.

On the other hand, when there is no destination (unprocessed destination) that has not been selected (NO in S16011), the transfer control section 410 advances the process to S16012 because it is confirmed that the transfer is not prohibited for all the destinations registered in the group destination.

In S16012, the transfer control section 410 transfers the data received in S12002 to all the destinations registered in the group destination. Specifically, the transfer control section 410 transmits the data obtained by converting the data received in S12002 into the type (file format) 11005 to each destination registered in the group destination set as the transfer destination 11004 of the transfer setting in FIG. 11A. After transmitting the data, the transfer control section 410 advances the process to S12015.

In the second embodiment, when the transfer control section 410 determines in S12011 that the mail is to be transmitted at the time of the transfer restriction (YES in S12011), the process advances to S16002.

In S16002, as well as in S12012 of FIG. 12, the transfer control section 410 transmits the mail having the contents that cannot be transferred due to the transfer restriction. When the address for which the transfer is restricted is a single address, the process is the same as that in S12012. However, when the address for which the transfer is restricted is in the group destination, the mail transmission is performed by switching between the text in FIG. 15A and the text in FIG. 15B depending on whether the setting of the transfer restriction operation of the group destination in FIG. 14 is the selection of the button 14001 or the selection of the button 14002.

Specifically, the transfer control section 410 confirms whether or not the transfer destination is the group destination in S16001 above, and when the transfer destination is not the group destination, creates the mail with the text of FIG. 9. When the transfer destination is the group destination, the transfer control section 410 further confirms whether or not the setting of the transfer restriction operation of the group destination in FIG. 14 is set to the button 14001, and when the setting is set to the button 14001, creates the mail with the text of FIG. 15A.

On the other hand, when the setting of the transfer restriction operation of the group destination in FIG. 14 is set to the button 14002, the transfer control section 410 creates the mail with the text of FIG. 15B. After transmitting the e-mail, the transfer control section 410 advances the process to S12013.

According to the above process, even when the received data is transferred to the group destination, the transfer can be prohibited according to the destination registered in the group destination. As a result, it is possible to suppress occurrence of a situation in which data is transmitted to a transmission-prohibited line via the gateway. That is, it is possible to suppress unintended data transfer among the plurality of lines.

In addition, the MFP may perform the following operations.

When the setting 10001 as to whether or not to perform the network data separation in FIG. 10 is changed from OFF to ON, the MFP may set the registered transfer condition to OFF so as not to perform the transfer. This is because the transfer restriction is not set in the transfer condition set in the state where the network data separation is OFF, and therefore, the transfer condition is once set to OFF so that unintended transfer is not performed.

Specifically, the transfer control section 410 confirms whether or not the setting 10001 as to whether or not to perform the network data separation has been changed from OFF to ON. When detecting that the setting 10001 is changed from OFF to ON, the transfer control section 410 changes the setting of the setting 11009 as to whether or not the transfer condition is validated from ON to OFF in the transfer conditions registered in FIG. 11A.

At this time, a message (e.g., e-mail) may be transmitted to the destination of an administrator or the like to confirm the transfer setting.

Further, in a case where the transfer time has been set in the time specification 11006 and the received data is in the state of waiting for the transfer time set in the time specification 11006, the MFP may invalidate the transfer of the data being in the state of waiting for the transfer time when the setting of the network line is changed.

Specifically, when it is detected that the settings of the network I/Fs 220 and 221 are changed, the network control section 407 notifies the transfer control section 410 of the change, and when there is the data in the state of waiting for the transfer until the set transfer time, the transfer control section 410 invalidates the transfer of the data. This is because the transfer of the data being in the state of waiting for the transfer time is determined whether or not the transfer is possible before the setting of the network line is changed, and therefore, the transfer is temporarily invalidated so that the unintended transfer is not performed.

In this case, after the transfer of all the data waiting for the transfer time is once invalidated, the process as shown in FIG. 12 or FIG. 16 may be performed again on these data to determine whether or not to perform the transfer again.

As described above, in each of the embodiments, in the MFP 100, the transfer restriction condition (the transfer restriction 11008 in FIG. 11A, and the restriction line 11102 and the transfer restriction 11103 in FIG. 11B) is set for each transfer condition related to the Internet fax function, the data transmitted from the external apparatus is received by the Internet fax function via any of the plurality of network I/Fs, and it is determined whether or not to execute the transmission of the received data based on the network information indicating the network I/F used in the reception and the destination information according to the transfer condition (S12004 to S12009).

The data determined to be transmitted is transmitted using the destination information via any of the plurality of network I/Fs (S12014).

The data determined not to be transmitted is not transmitted using the destination information (S12010 to S12013). As a result, in the data processing apparatus such as the MFP that has the plurality of network interfaces and the Internet fax function, when the transfer function of the data received by the Internet fax function is used, it is possible to properly control execution/prohibition of the data transfer.

As a result, it is possible to suppress the occurrence of the situation in which the data is transmitted to the transmission-prohibited line via the gateway. That is, it is possible to suppress the unintended data transfer among the plurality of lines for the data received by the Internet fax function.

Note that the disclosure is not limited to the image forming apparatus such as the MFP (multifunction peripheral), and can be applied to any apparatus as long as it is a data processing apparatus including a plurality of network interfaces.

It is needless to say that the configuration and the contents of the various kinds of data described above are not limited thereto, and various configurations and contents are configured according to the application and the purpose.

Although the embodiments of the disclosure have been described above, the disclosure can be implemented as, for example, a system, an apparatus, a method, a program, or a storage medium. Specifically, the disclosure may be applied to a system including a plurality of devices, or may be applied to an apparatus including one device.

In addition, all configurations in which the above embodiments are combined are also included in the disclosure.

According to the disclosure, unintended data transfer among the plurality of network interfaces can be suppressed for the data received by the Internet fax function.

### Other Embodiments

Embodiment(s) of the disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of Japanese Patent Application No. 2024-209029, filed November 29, 2024, which is hereby incorporated by reference herein in its entirety.

What is claimed is:

1. An apparatus having a plurality of network interfaces and an Internet fax function, comprising:
at least one processor; and
at least one memory coupled to the at least one processor storing instructions that, when executed by the at least one processor, cause the at least one processor to function as:
a receiving unit configured to receive data transmitted from an external apparatus, by the Internet fax function via any of the plurality of network interfaces;
a determining unit configured to determine whether or not to execute transmission of the received data, based on network information indicating the network interface used in a case where the receiving unit receives the data, and destination information according to a transfer condition related to the Internet fax function; and
a transmitting unit configured to execute, via any of the plurality of network interfaces, the transmission of the received data and for which the determining unit determines that the transmission is executed, the transmission being executed according to the transfer condition and using the destination information,
wherein the transmission using the destination information is not executed on the received data and for which the determining unit determines that the transmission is not executed.

2. The apparatus according to claim 1, further comprising:
a storing unit configured to store, as restriction information for restricting the transmission of the data by the transmitting unit, the network information indicating the network interface used in the case where the receiving unit receives the data, and information of at least any of a type of a destination for which the transmission of the data by the transmitting unit is permitted and a type of a destination for which the transmission of the data by the transmitting unit is not permitted,
wherein the determining unit determines whether or not to execute the transmission of the data using the restriction information stored in the storing unit.

3. The apparatus according to claim 2, further comprising a setting unit configured to set the restriction information.

4. The apparatus according to claim 3, wherein the setting unit sets the restriction information for each transfer condition.

5. The apparatus according to claim 1, wherein
in a case where the destination information is a group including a plurality of destination information, the determining unit determines whether or not to execute the transmission of the received data for each destination information included in the group, the transmission being executed using the destination information,
for the received data and for which the determining unit determines that the transmission using at least any of the destination information included in the group is executed, the transmission using the destination information for which it is determined to execute the transmission is executed by the transmitting unit, and the transmission using the destination information for which it is determined to not execute the transmission is not executed, and
for the received data and for which the determining unit determines that the transmission using any of the destination information included in the group is not executed, the transmission using any of the destination information included in the group is not executed.

6. The apparatus according to claim 1, wherein
in a case where the destination information is a group including a plurality of destination information, the determining unit determines whether or not to execute the transmission of the received data for each destination information included in the group, the transmission being executed using the destination information,
for the received data and for which the determining unit determines that the transmission using the destination information is executed for all the destination information included in the group, the transmission using the respective destination information included in the group is executed by the transmitting unit, and
for the received data and for which the determining unit determines that the transmission using at least any of the destination information included in the group is not executed, the transmission using any of the destination information included in the group is not executed.

7. The apparatus according to claim 1, further comprising a notifying unit configured to perform, to a predetermined notification destination, notification of the received data and for which the transmission using the destination information is not executed.

8. The apparatus according to claim 1, wherein, in a case where a setting of the plurality of network interfaces is changed, the transmission using the destination information is not executed for the data for which the determining unit determines that the transmission is executed and which is not yet transmitted.

9. A method of an apparatus having a plurality of network interfaces and an Internet fax function, the method comprising:
receiving data transmitted from an external apparatus, by the Internet fax function via any of the plurality of network interfaces;
determining whether or not to execute transmission of the received data, based on network information indicating the network interface used in a case where the data is received and destination information according to a transfer condition related to the Internet fax function; and
executing, via any of the plurality of network interfaces, the transmission of the received data for which it is determined that the transmission is executed, the transmission being executed according to the transfer condition and using the destination information,
wherein the transmission using the destination information is not executed on the received data for which it is determined that the transmission is not executed.

10. The method according to claim 9, further comprising:
storing, as restriction information for restricting the transmission of the data by the transmitting, the network information indicating the network interface used in the case where the receiving receives the data, and information of at least any of a type of a destination for which the transmission of the data by the transmitting is permitted and a type of a destination for which the transmission of the data by the transmitting is not permitted,
wherein the determining determines whether or not to execute the transmission of the data using the restriction information stored in the storing.

11. The method according to claim 9, wherein
in a case where the destination information is a group including a plurality of destination information, the determining determines whether or not to execute the transmission of the received data for each destination information included in the group, the transmission being executed using the destination information,
for the received data and for which the determining determines that the transmission using at least any of the destination information included in the group is executed, the transmission using the destination information for which it is determined to execute the transmission is executed by the transmitting, and the transmission using the destination information for which it is determined to not execute the transmission is not executed, and
for the received data and for which the determining determines that the transmission using any of the destination information included in the group is not executed, the transmission using any of the destination information included in the group is not executed.

12. The method according to claim 9, wherein
in a case where the destination information is a group including a plurality of destination information, the determining determines whether or not to execute the transmission of the received data for each destination information included in the group, the transmission being executed using the destination information,
for the received data and for which the determining determines that the transmission using the destination information is executed for all the destination information included in the group, the transmission using the respective destination information included in the group is executed by the transmitting, and
for the received data and for which the determining determines that the transmission using at least any of the destination information included in the group is not executed, the transmission using any of the destination information included in the group is not executed.

13. The method according to claim 9, further comprising performing, to a predetermined notification destination, notification of the received data and for which the transmission using the destination information is not executed.

14. The method according to claim 9, wherein, in a case where a setting of the plurality of network interfaces is changed, the transmission using the destination information is not executed for the data for which the determining determines that the transmission is executed and which is not yet transmitted.

15. A non-transitory computer-readable storage medium storing a program for causing a computer equipped in the apparatus having a plurality of network interfaces and an Internet fax function to execute the method, of the comprising:
receiving data transmitted from an external apparatus, by the Internet fax function via any of the plurality of network interfaces;
determining whether or not to execute transmission of the received data, based on network information indicating the network interface used in a case where the data is received and destination information according to a transfer condition related to the Internet fax function; and
executing, via any of the plurality of network interfaces, the transmission of the received data for which it is determined that the transmission is executed, the transmission being executed according to the transfer condition and using the destination information,
wherein the transmission using the destination information is not executed on the received data for which it is determined that the transmission is not executed.

16. The non-transitory computer-readable storage medium according to claim 15, further comprising:
storing, as restriction information for restricting the transmission of the data by the transmitting, the network information indicating the network interface used in the case where the receiving receives the data, and information of at least any of a type of a destination for which the transmission of the data by the transmitting is permitted and a type of a destination for which the transmission of the data by the transmitting is not permitted,
wherein the determining determines whether or not to execute the transmission of the data using the restriction information stored in the storing.

17. The non-transitory computer-readable storage medium according to claim 15, wherein
in a case where the destination information is a group including a plurality of destination information, the determining determines whether or not to execute the transmission of the received data for each destination information included in the group, the transmission being executed using the destination information,
for the received data and for which the determining determines that the transmission using at least any of the destination information included in the group is executed, the transmission using the destination information for which it is determined to execute the transmission is executed by the transmitting, and the transmission using the destination information for which it is determined to not execute the transmission is not executed, and
for the received data and for which the determining determines that the transmission using any of the destination information included in the group is not executed, the transmission using any of the destination information included in the group is not executed.

18. The non-transitory computer-readable storage medium according to claim 15, wherein
in a case where the destination information is a group including a plurality of destination information, the determining determines whether or not to execute the transmission of the received data for each destination information included in the group, the transmission being executed using the destination information,
for the received data and for which the determining determines that the transmission using the destination information is executed for all the destination information included in the group, the transmission using the respective destination information included in the group is executed by the transmitting, and
for the received data and for which the determining determines that the transmission using at least any of the destination information included in the group is not executed, the transmission using any of the destination information included in the group is not executed.

19. The non-transitory computer-readable storage medium according to claim 15, further comprising performing, to a predetermined notification destination, notification of the received data and for which the transmission using the destination information is not executed.

20. The non-transitory computer-readable storage medium according to claim 15, wherein, in a case where a setting of the plurality of network interfaces is changed, the transmission using the destination information is not executed for the data for which the determining determines that the transmission is executed and which is not yet transmitted.
